(19) United States
(12) Patent Application Publication
(10) Pub. No.: US 2026/0297329 A1
(43) Pub. Date: Oct. 1, 2026

(54) CURABLE COMPOSITION AND CURED COMPOSITIONS DERIVED THEREFROM

(71) Applicant: ROGERS CORPORATION, Chandler, AZ (US)

(72) Inventors: William Scholz, Scottsdale, AZ (US); Wayne Wilson, Mesa, AZ (US); Tanya Singh-Rachford, Grafton, MA (US); Nazeef Azam, Manchester, CT (US); Bryan Tworzydlo, Woodstock, CT (US)

(21) Appl. No.: 19/635,065

(22) Filed: Mar. 31, 2026

Related U.S. Application Data
(60) Provisional application No. 63/781,472, filed on Apr. 1, 2025.

(51) Int. Cl. C08L 101/02; C08F 8/04; C08F 297/00; C08F 299/00; C08K 3/36; C08K 5/02; C08K 5/14; C08K 7/28

(52) U.S. Cl. CPC C08L 101/02; C08F 299/00; C08K 3/36; C08K 5/02; C08K 5/14; C08K 7/28; C08F 8/04; C08F 297/00; C08L 2205/03; C08L 2205/05

(57) ABSTRACT

A curable composition including: a hydrogenated block copolymer including at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; a first crosslinkable component including a polymeric reactive diluent having a glass transition temperature of greater than or equal to 100° C. and at least one crosslinkable reactive group; a second crosslinkable component including a polyaromatic vinyl compound; and a filler.

### CROSS-REFERENCE TO RELATED APPLICATION

The present application claims the benefit of priority to U.S. Application No. 63/781,472, filed Apr. 1, 2025, the content of which is incorporated by reference in its entirety herein.

### BACKGROUND

This disclosure is directed to curable compositions, cured compositions derived therefrom, and use of the cured compositions in various applications.

Curable compositions are useful for a variety of applications. It would be especially desirable to provide curable compositions which exhibit good film formation and high cohesive strength, long shelf-life with storage at room temperature, excellent fill and flow characteristics at low lamination temperatures, best in class electrical loss, low permittivity (e.g., Dk 3.0), a low coefficient of thermal expansion (CTE) (e.g., less than about 40 parts per million (ppm)/° C. over a temperature range of −40 and 140° C.), and strong bonding to electroless and electroplated copper conductors and copper foils. Such compositions can be useful in applications including, for example, resin coated copper, bondply, copper clad laminates, and build-up films.

There remains a continuing need in the art for compositions which can provide a combination of the above-mentioned properties.

### SUMMARY

A curable composition including: 4.9 to 15 weight percent, or 4.9 to 14 weight percent, or 4.9 to 13 weight percent, or 4.9 to 12 weight percent, of a hydrogenated block copolymer including at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; 4 to 13 weight percent, or 5 to 12 weight percent, or 5 to 11 weight percent, of a first crosslinkable component including a polymeric reactive diluent having a glass transition temperature of greater than or equal to 100° C. and at least one crosslinkable reactive group; and 4 to 13 weight percent, or 5 to 12 weight percent, or 5 to 11 weight percent, of a second crosslinkable component including a polyaromatic vinyl compound; wherein weight percent of each component is based on a total weight of dry components of the curable composition; and wherein the curable composition further includes 36 to 54 volume percent, or 36 to 51 volume percent, of a filler, wherein volume percent of the filler is based on a total volume of dry components of the curable composition.

A curable composition including: 4.9 to 11.6 weight percent of a hydrogenated block copolymer including at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; 6.4 to 10 weight percent of a first crosslinkable component including a polymeric reactive diluent having a glass transition temperature of greater than or equal to 100° C. and at least one crosslinkable reactive group; 5.1 to 8.8 weight percent of a second crosslinkable component including a polyaromatic vinyl compound; and 61.2 to 69.8 weight percent of a filler; wherein weight percent of each component is based on a total weight of dry components of the curable composition.

A varnish includes the curable composition.

A cured composition can be obtained from the curable composition.

A composite laminate includes the cured composition.

The above described and other features are exemplified by the following detailed description.

### BRIEF DESCRIPTION OF THE DRAWINGS

The following figures represent exemplary embodiments.

FIG. 1 is a photograph of the flow evaluation of Example 2;

FIG. 2 is a photograph of the flow evaluation of Example 3;

FIG. 3 is a photograph of the flow evaluation of Example 4;

FIG. 4 is a photograph of the flow evaluation of Example 5;

FIG. 5 is a photograph of the flow evaluation of Example 6;

FIG. 6 is a schematic diagram of the article used for cross ply tensile testing;

FIG. 7 is a photograph of cross ply tensile testing results;

FIG. 8 is a photograph of cross ply tensile testing results;

FIG. 9 is a photograph of cross ply tensile testing results; and

FIG. 10 is a photograph of cross ply tensile testing results.

### DETAILED DESCRIPTION

The present inventors have identified curable compositions that can be tailored to provide a desirable combination of properties including good dielectric properties, good copper peel strength, good CTE, and in some instances, improved flame-retardant properties. The curable compositions can advantageously be cured to form products suitable for a variety of applications, including as build-up films, polytetrafluoroethylene (PTFE) replacement products, and for use in copper clad laminates. A significant improvement is provided by the present disclosure.

Provided is a curable composition. The curable composition includes a hydrogenated block copolymer, a first crosslinkable component including a polymeric reactive diluent having a glass transition temperature of greater than or equal to 100° C. and at least one crosslinkable reactive group, a second crosslinkable component including a polyaromatic vinyl compound, and a filler.

The hydrogenated block copolymer includes at least one A block and at least one B block. For example, the hydrogenated block copolymer can be of the structure A-B, A-B-A, (A-B)ₙX, A-B-A-B, (B-A-B)ₙX, (B-A)ₙX, and (A-B-A)ₙX, wherein X is a coupling agent residue and n is 1 to 30. In the hydrogenated block copolymer, prior to hydrogenation, each A block is a rigid block derived from a first vinyl aromatic compound, and each B block is a copolymer derived from (a) a second vinyl aromatic compound (e.g., a styrenic compound), (b) a conjugated diene, and optionally (c) a third vinyl aromatic compound. The second and third vinyl aromatic compounds can be the same or different.

The first vinyl aromatic compound can be any aromatic compound having at least one vinyl group attached thereto. Exemplary classes of compounds can include substituted and unsubstituted styrenes, substituted and unsubstituted vinyl naphthalenes, vinyl indenes, vinyl anthracenes, 1,1-diphenyl ethylene, or a combination thereof. Examples can include C₈₋₂₀ vinyl aromatic compounds, such as o-methylstyrene, p-methylstyrene, p-tert-butylstyrene, 2,4-dimethylstyrene, alpha-methylstyrene, vinylnaphthalene, vinyltoluene and vinylxylene, or a combination thereof. The first vinyl aromatic compound can be para-methylstyrene.

The second vinyl aromatic compound can be a styrenic compound, for example, a styrenic compound according to Formula (I), a vinyl benzocyclobutene according to Formula (II), a vinyl dihydroindene of Formula (III), a vinyl tetrahydronaphthalene of Formula (IV), or a combination thereof.

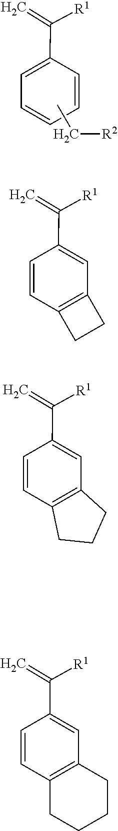

In the foregoing Formulas, R¹ is hydrogen or methyl and R² is hydrogen or a monovalent alkyl group. The monomer (a) of the B block can be o-methylstyrene, p-methylstyrene, o-ethyl styrene, p-ethyl styrene, o-isopropylstyrene, para-isopropylstyrene, o-methyl-a-methylstyrene, p-methyl-a-methylstyrene, o-ethyl-a-methylstyrene, p-ethyl-a-methylstyrene, o-isopropyl-a-methylstyrene, para-isopropyl-a-methylstyrene, or a combination thereof.

The conjugated diene of the B block of the hydrogenated block copolymer can include butadiene, isoprene, 2,3-dimethyl-1,3-butadiene, 1-phenyl-1,3-butadiene, 1,3-pentadiene, 1,3-hexadiene, 3-butyl-1,3-octadiene, farnesene, myrcene, piperylene, cyclohexadiene, or a combination thereof. When present, the third vinyl aromatic compound can be any aromatic compound having at least one vinyl group attached thereto, and can be as disclosed herein for the first vinyl aromatic compound.

The A block can have a peak molecular weight (Mp) of 3 to 60 kilograms per mole (kg/mol), or 5 to 50 kg/mol, or 10 to 45 kg/mol, or 15 to 40 kg/mol, or 20 to 35 kg/mol, or greater than 10 kg/mol, or less than 50 kg/mol. The B block can have a Mp of 20 to 200 kg/mol, or 30 to 180 kg/mol, or 40 to 160 kg/mol, or 50 to 140 kg/mol, or 60 to 120 kg/mol, or greater than 20 kg/mol, or less than 160 kg/mol. Molecular weight in the context of the hydrogenated block copolymer refers to the styrene equivalent molecular weight, for example measured by gel permeation chromatography (GPC) relative to polystyrene standards.

The polymerized units of the B block derived from the monomer (a) (i.e., the second vinyl aromatic compound) can constitute from 10 to 80 weight percent, or 15 to 75 weight percent, or 20 to 70 weight percent, or 25 to 60 weight percent, or 30 to 65 weight percent, or greater than 15 weight percent, or less than 75 weight percent, each based on the total weight of the B block of the hydrogenated block copolymer. The polymerized units of the B block derived from the monomer (a) can constitute from 10 to 70 weight percent, or 15 to 65 weight percent, or 20 to 60 weight percent, or 25 to 55 weight percent, or 30 to 50 weight percent, or greater than 15 weight percent, or less than 65 weight percent, each based on the total weight of the hydrogenated block copolymer.

After hydrogenation, the hydrogenated block copolymer can have a residual olefinic unsaturation content of 0 to 1.5 milliequivalents per gram (meq/g) of olefinic C═C groups. Residual olefinic unsaturation can be measured, for example, by ozone titration or by proton nuclear magnetic resonance (¹H NMR) spectroscopy. Within the disclosed range, the residual olefinic unsaturation content can be 0.01 to 1.4 meq/g, or 0.02 to 1.3 meq/g, 0.05 to 1.2 meq/g, or 0.1 to 1.1 meq/g, or 0.2 to 1.0 meq/g, or 0.025 to 0.8 meq/g, or greater than 0 meq/g, or less than 1.0 meq/g.

The hydrogenated block copolymer can include 10 to 50 weight percent of polymerized units derived from para-methylstyrene or 15 to 45 weight percent, or 20 to 40 weight percent, or greater than 15 weight percent, or less than 60 weight percent, each based on the total weight of the hydrogenated block copolymer.

The hydrogenated block copolymer can have a corrected 1,4-diene unit content from 10 to 70 weight percent, or 15 to 65 weight percent, or 20 to 60 weight percent, or 25 to 55 weight percent, or greater than 15 weight percent, or less than 65 weight percent, each based on the total weight of the hydrogenated block copolymer. The B block can have a corrected 1,4-diene unit content of 10 to 60 weight percent, or 15 to 55 weight percent, or 20 to 50 weight percent, or 25 to 45 weight percent, or greater than 15 weight percent, or less than 55 weight percent, each based on the total weight of the B block. Corrected 1,4-diene content (C14DUC) as used herein refers to a polymer block having repeat units derived from butadiene (Bd), isoprene (Ip) or a combination thereof, and is mathematically given in terms of the parameters: weight percent Bd content (B_{w}) in the total dienes in the polymer block, weight percent of 1,4-addition units of Bd (B14) in the Bd units in the polymer block, weight percent Ip content (I_{w}) in the total dienes in the polymer block, and weight percent of 1,4-addition units of Ip (I14) in the Ip units in the polymer block, by equation (1):

$$C 14 DUC = ( {B}_{w} * B 14 / 100 ) + {I}_{w} * ( I 14 - 40 ) / 100 \qquad ( 1 )$$

Polymerization of a conjugated diene gives rise to polymerized units that are based on addition across both double bonds (giving rise to 1,4-addition units) as well as one double bond (giving rise to side vinyl groups).

The B block can be derived from para-methylstyrene and a conjugated diene of isoprene, butadiene, or a combination thereof. The hydrogenated block copolymer can optionally further include a C block, which can be derived from a conjugated diene, for example butadiene, isoprene, or a combination thereof. The C block can be hydrogenated.

Exemplary hydrogenated block copolymers useful in the curable composition of the present disclosure, and methods for the manufacture thereof, can be as further described in U.S. Publication No. 2022/0049083, the contents of which is hereby incorporated by reference in its entirety and can include those available as MD3501 from Kraton Corporation.

Hydrogenated block copolymers with lower molecular weights can provide desirable flow properties in the curable composition.

The hydrogenated block copolymer can be present in the curable composition in an amount of 4.9 to 15 weight percent, or 4.9 to 14 weight percent, or 4.9 to 13 weight percent, or 4.9 to 12 weight percent, based on the total weight of dry components of the curable composition. An amount of hydrogenated block copolymer greater than 15 weight percent, based on the total weight of dry components of the curable composition, can lead to undesirable characteristics in the curable composition, for example, results of the Underwriter's Laboratory UL 94 Standard For Safety “Tests for Flammability of Plastic Materials for Parts in Devices and Appliances,” CTE, and minimum viscosity (flow). The curable composition can have a desirable minimum viscosity of, for example, less than 4.9E+04.

The hydrogenated block copolymer can be present in the composition in an amount of 4.9 to 11.6 weight percent, based on the total weight of dry components of the curable composition. Within this range, the hydrogenated block copolymer can be present in an amount of at least 8.

The curable composition further includes a first crosslinkable component including unsaturation that is capable of participating in a crosslinking reaction (e.g., free radical crosslinking).

The first crosslinkable component includes a polymeric reactive diluent having a glass transition temperature of greater than or equal to 100° C. and at least one crosslinkable reactive group. The Tg of the polymeric reactive diluent can be in the range of 100 to 300° C., or 110 to 300° C. The polymeric reactive diluent can have a number average molecular weight of 800 to 10,000 grams per mole (g/mol) and a weight average molecular weight of 1,000 to 500,000 grams per mole (g/mol). Within this range, the weight average molecular weight can be at least 2,000 g/mol, or at least 3,000 g/mol, or at least 5,000 g/mol, and at most 100,000, or at most 50,000 g/mol, or at most 30,000 g/mol, or at most 15,000 g/mol (for example as determined by gel permeation chromatography relative to polystyrene).

The polymeric reactive diluent can include a polymer having crosslinkable reactive groups, a Tg of 100 to 300° C., a number average molecular weight of 800 to 10,000 g/mol, and a weight average molecular weight of 1,000 to 15,000 grams per mole. Exemplary materials can include, but are not limited to, those obtained as ELPAC™ HC-G series polymers, including ELPAC™ HC-G0024 from JSR Corporation.

The polymeric reactive diluent can be included in the curable composition in an amount of 4 to 13 weight percent, or 5 to 12 weight percent, or 5 to 11 weight percent, based on the total weight of dry components of the curable composition. An amount of polymeric reactive diluent greater than 13 weight percent, based on the total weight of dry components of the curable composition, can lead to undesirable brittleness in films formed from the curable composition.

The polymeric reactive diluent can be included in the curable composition in an amount of 6.4 to 10 weight percent, based on the total weight of dry components of the curable composition.

The curable composition further includes a second crosslinkable component including a polyaromatic vinyl compound. The second crosslinkable component can be a compound represented by formula (1).

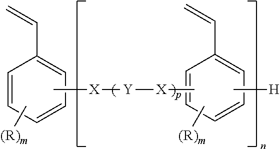

In formula (1), X and Y each represent a different optional organic group. When there are a plurality of X, the plurality of X can be the same as or different from each other. When there are a plurality of Y, the plurality of Y can be the same as or different from each other. R is a hydrocarbon group having 1 to 10 carbon atoms or a halogenated alkyl group. When there are a plurality of R, the plurality of R can be the same as or different from each other. The variable m is an integer of 0 to 3, for example, an integer of 0 to 2 or 0, n represents a repeating unit and satisfies 1≤n≤20, for example, 1.1≤n≤20, 1.1≤n≤10, or 1.1≤n≤5, and p represents a repeating unit and satisfies 0≤p≤20. The lower limit value of p is, for example, 0 or 1. The upper limit value of p is 20, for example, 10, 5, 3, or 0.

The value of n can be calculated from a value of the weight average molecular weight (Mw) of the compound determined by gel permeation chromatography (GPC) measurement. The weight average molecular weight is, for example, 200 or more and less than 5,000, 300 or more and less than 3,000, or 400 or more and less than 2,000.

R is a hydrocarbon group having 1 to 10 carbon atoms, for example, a hydrocarbon group having 1 to 5 carbon atoms or a hydrocarbon group having 1 to 3 carbon atoms. When R is a hydrocarbon group having 10 or less carbon atoms, the compound can be less likely to undergo molecular vibration when exposed to high frequencies, and the compound can have excellent electrical properties.

In formula (1), X represents, for example, any one or more of structures (A) to (D) of in formula (2), structure (A) or (C), or structure (A). Due to a nonpolar and rigid structure, the distance between crosslinking points and the aromatic ring density derived from these structures, the cured product is excellent in various properties such as electrical properties, heat resistance, low water absorption, toughness (mechanical strength), adhesion, and flame retardancy.

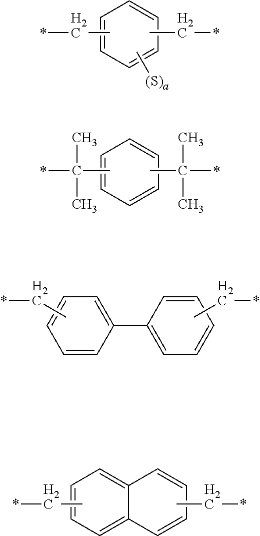

S is a hydrocarbon group having 1 to 3 carbon atoms, for example, a methyl group, and a is an integer of 0 to 4, for example 0 or 1 or 0. When there are a plurality of S, the plurality of S can be the same as or different from each other. The symbol * indicates a bonding position.

In formula (1), Y represents, for example, any one or more of structures (E) to (K) of formula (3), structure (E) or (F), or structure (E).

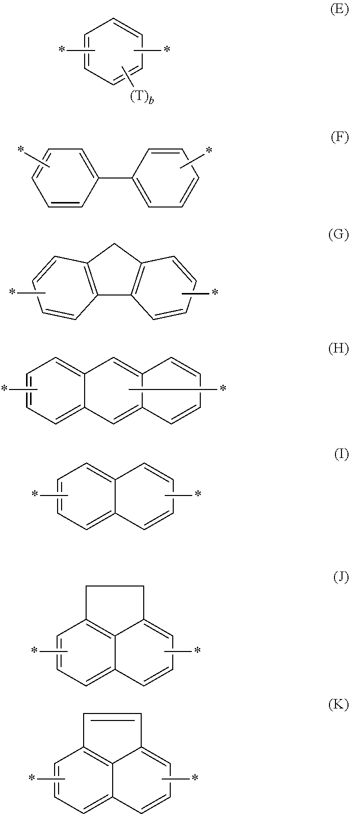

T is a hydrocarbon group having 1 to 3 carbon atoms, for example, a methyl group, and b is an integer of 0 to 4, for example, an integer of 0 to 3 or 3. When there are a plurality of T, the plurality of T can be the same as or different from each other. The symbol * indicates a bonding position.

The second crosslinkable component can be a compound represented by formula (4).

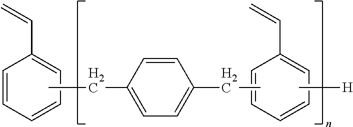

The Tg of the second crosslinkable component can be greater than 200° C., or greater than 350° C. The aromatic groups contribute to the relatively high Tg of the second crosslinkable component.

The second crosslinkable component can be included in the curable composition in an amount of 4 to 13 weight percent, or 5 to 12 weight percent, or 5 to 11, based on the total weight of dry components of the curable composition. An amount of polymeric reactive diluent greater than 13 weight percent, based on the total weight of dry components of the curable composition, can lead to undesirable Df and minimum viscosity (flow) in the curable composition.

The second crosslinkable component can be included in the curable composition in an amount of 6.4 to 10 weight percent, based on the total weight of dry components of the curable composition.

The curable composition further includes a filler. The filler can be selected to adjust one or more desired properties including dielectric constant, dissipation factor, CTE, and other properties of a cured composition derived from the curable composition. Exemplary fillers can include, but are not limited to, titanium dioxide (such as rutile and anatase), barium titanate, strontium titanate, silica (including fused amorphous silica), corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, magnesium hydroxide, or a combination thereof.

The filler can include silica. The silica can include solid silica particles, hollow silica particles, or a combination thereof. The silica can include solid silica particles. The silica can include hollow silica particles. The silica can include a combination of solid silica particles and hollow silica particles, for example, hollow soda-lime-borosilicate glass microspheres. When a combination is used, the solid and hollow silicas can be present in a solid:hollow volume ratio of greater than or equal to 90:10, for example 90:10 to 100:0, or 92:8 to 100:0, or 95:5 to 100:0. The silica can have a D50 particle size of 0.2 to 20 micrometers, or 1 to 15 micrometers, or 1 to 10 micrometers, or 1 to 5 micrometers. The particle size can be determined using dynamic light scattering. The D50 refers to 50% by volume of the particles having a particle size below the number. The solid and hollow silicas can be present in a solid:hollow volume ratio of greater than or equal to 80:20, for example, 80:20 to 100:0 or 80:20 to 90:10.

The filler can include microspherical silica, fused spherical vinyl treated silica, hollow soda-lime-borosilicate glass microspheres, or a combination thereof. The hollow soda-lime-borosilicate glass microspheres can be present in an amount of 0 to 2.8 weight percent, based on the total weight of dry components of the curable composition. The fused spherical vinyl treated silica can be present in an amount of 61.2 to 67 weight percent, based on the total weight of dry components of the curable composition. The filler can include hollow soda-lime-borosilicate glass microspheres and a solid silica having a D50 of greater than or equal to 8 micrometers (μm). Without wishing to be bound by any theory, it is believed that the solid silica having a D50 of greater than or equal to 8 micrometers can improve flow characteristics and bond properties. The hollow soda-lime-borosilicate glass microspheres and solid silica can help provide a desirable, e.g., lower, Dk to the cured composition including same. Hollow soda-lime-borosilicate glass microspheres can be less expensive and more readily available than solid silica, and inclusion of hollow soda-lime-borosilicate glass microspheres can provide desirable results at a lower cost as compared to using only solid silica. D50 can be measured using a laser diffraction method to measure particle size distributions, for example, using a Horiba LA-951 instrument.

The end use of a cured composition obtained from the curable composition can contribute to choice of filler included in the curable composition, for example, based on the size of the filler. For example, the thickness of a build-up film can be less than the thickness of a bondply, and a curable composition to be used to form a build-up film can include smaller silica particles than a curable composition to be used to form a bondply.

The curable composition includes 36 to 54 volume percent, or 36 to 51 volume percent, of the filler, wherein volume percent of the filler is based on a total volume of dry components of the curable composition. Filler volume percent can affect CTE and Df of the curable composition. For example, an increase in the amount of filler can decrease CTE and Df of the curable composition and reduce flow properties. The curable composition can include 36 to 54 volume percent, or 36 to 51 volume percent, of fused spherical vinyl treated silica, wherein volume percent of the filler is based on a total volume of dry components of the curable composition.

The filler can be included in the curable composition in an amount of 61.2 to 69.8 weight percent, based on the total weight of dry components of the curable composition. Within this range, the filler can be present in an amount of at least 65 weight percent, based on the total weight of dry components of the curable composition.

The filler can include fused silica, fumed silica, a silane treated fumed silica, titanium dioxide, barium titanate, strontium titanate, corundum, wollastonite, Ba₂Ti₉O₂₀, hollow ceramic spheres, boron nitride, aluminum nitride, silicon carbide, beryllia, alumina, alumina trihydrate, magnesia, mica, talc, nanoclay, magnesium hydroxide, or a combination thereof. The surface of filler can be modified using physical vapor deposition (PVD), chemical vapor deposition (CVD) such as, for example, atomic layer deposition (ALD), or a combination thereof.

The filler can include a fused silica. All or a portion of the fused silica can be capable of chemically coupling to the crosslinked network. The fused silica can include a surface treatment, for example, to hydrophobize the fused silica. The surface treatment can be formed by grafting a silane onto the fused silica. The silane can include a reactive end group capable of chemically coupling to the crosslinked network.

The fused silica can be functionalized with functional groups including at least one of a (meth)acrylate group, a vinyl group, an allyl group, a propargyl group, a butenyl group, a styryl group, phenylamino group or a vinyl benzyl group; preferably wherein a functional group of the functionalized fused silica includes a (meth)acrylate group. Silanes including a polymerizable functional group include silanes of the formula R^{a}ₓSiR^{b}₍₃₋ₓ₎R, in which each R^{a} is the same or different (for example, the same) and is halogen (for example, Cl or Br), C₁₋₄ alkoxy (for example, methoxy or ethoxy), or C₂₋₆ acyl; each R^{b} is a C₁₋₈ alkyl or C₆₋₁₂ aryl (for example, R^{b} can be methyl, ethyl, propyl, butyl or phenyl); x is 1, 2 or 3 (for example, 2 or 3); and R is —(CH₂)ₙOC(═O)C(R^{c})═CH₂, wherein R^{c} is hydrogen or methyl and n is an integer 1 to 6, or, 2 to 4. The silane can include methacrylsilane(3-methacryloxypropyl trimethoxy silane), trimethooxyphenylsilane, or a combination thereof.

The curable composition can further include one or more optional components.

For example, the curable composition can optionally further include an initiator, a flame retardant, an additive composition, a second reactive diluent, or a combination thereof.

The curable composition can further include an initiator. The initiator can decompose (e.g., thermally) to form free radicals, which then initiate polymerization of crosslinkable groups within the formulation. The initiator can provide weak bonds, for example, bonds that have small dissociation energy. The free-radical initiator can include at least one of a peroxide initiator, an azo initiator, a carbon-carbon initiator, a persulfate initiator, a hydrazine initiator, a hydrazide initiator, a benzophenone initiator, or a halogen initiator. The initiator can include a peroxide initiator. For example, the initiator can include an organic peroxide, for example, at least one of dicumyl peroxide, 2,5-dimethyl-2,5-di(t-butylperoxy)hexane, α,α′-di(t-butylperoxy)diisopropylbenzene, 2,5-dimethyl-2,5-di(t-butylperoxy)hexyne, or 3,1,1-di(t-butylperoxy)-3,5,5-trimethylcyclohexane. Optionally, the initiator can be light sensitive including, for example, α-hydroxy ketone, phenylglyoxylate, benzyldimethyl-ketal, α-amino ketone, monoacyl phosphine (MAPO), bisacyl phosphine (BAPO), phosphine oxides or metallocenes. The initiator can be present in an amount of 0.2 to 1.2 weight percent, based on the total weight of dry components of the curable composition. Combinations of initiators can be used.

The curable composition can further include the initiator in an amount of greater than 0 to 2 weight percent, or greater than 0 to 1 weight percent, or greater than 0 to 0.6 weight percent, based on the total weight of dry components of the curable composition.

The curable composition can optionally further include a flame retardant. The flame retardant can be halogenated or unhalogenated. The flame retardant can be present in the curable composition in an amount of 6.4 to 13.7 weight percent, based on the dry weight of the curable composition. The curable composition can include less than 10 weight percent, or less than 5 weight percent, or less than 1 weight percent, or 0 weight percent, of a flame retardant, based on the dry weight of the curable composition.

The curable composition can include, for example, 7 to 16.5 weight percent, or 7 to 14 weight percent, or 7 to 11.5 weight percent, of a halogenated, e.g., brominated, flame retardant, based on the total weight of the dry components of the curable composition. The curable composition can include, for example, 8 to 16.5 weight percent, or 8 to 14 weight percent, or 8 to 11.5 weight percent, of an unhalogenated or halogen-free flame retardant, based on the total weight of the dry components of the curable composition. A brominated flame retardant may be used in a lesser amount than a halogen-free flame retardant as a brominated flame retardant may be more active than a halogen-free flame retardant. A sum of a volume of the flame retardant and a volume of the filler can be 50 to 60 volume percent, based on a total volume of dry components of the curable composition.

The flame retardant can be inorganic and can be present in the form of particles. The inorganic flame retardant can include a metal hydrate, having, for example, a volume average particle diameter of 1 to 500 nanometers (nm), or 1 to 200 nm, or 5 to 200 nm, or 10 to 200 nm; alternatively the volume average particle diameter can be 500 nm to 15 μm, for example, 1 to 5 μm. The metal hydrate can include a hydrate of a metal, for example, at least one of Mg, Ca, Al, Fe, Zn, Ba, Cu, or Ni. Hydrates of Mg, Al, or Ca can be used, for example, at least one of aluminum hydroxide, magnesium hydroxide, calcium hydroxide, iron hydroxide, zinc hydroxide, copper hydroxide, nickel hydroxide, or hydrates of calcium aluminate, gypsum dihydrate, zinc borate or barium metaborate. Composites of hydrates can be used, for example, a hydrate containing Mg and at least one of Ca, Al, Fe, Zn, Ba, Cu, or Ni. A composite metal hydrate can have the formula MgMₓ(OH)_{y} wherein M is Ca, Al, Fe, Zn, Ba, Cu, or Ni, x is 0.1 to 10, and y is 2 to 32. The flame retardant particles can be coated or otherwise treated to improve dispersion and other properties.

Organic flame retardants can be used alternatively or in addition to the inorganic flame retardants. Examples of organic flame retardants include melamine cyanurate, fine particle size melamine polyphosphate, various other phosphorus-containing compounds such as aromatic phosphinates, diphosphinates, phosphonates, phosphates, polysilsesquioxanes, siloxanes, halogenated compounds (such as hexachloroendomethylenetetrahydrophthalic acid (HET acid), tetrabromophthalic acid, or dibromoneopentyl glycol), or dihydro-oxa-phospho-phenantrene (DOPO) derivatives (wherein by “derivative” is meant that one or more hydrogens in DOPO (CAS RN 35948-25-5) have been replaced by one or more substituents (such derivative also referred to as an “oxaphosphorinoxide-containing aromatic compound,” i.e. a compound containing at least one such DOPO radical or moiety)). A flame retardant (such as a bromine-containing flame retardant) can be present in an amount of 20 phr (parts per hundred parts of the curable composition by weight) to 60 phr, for example, 30 to 45 phr. Examples of brominated flame retardants include Saytex™ BT93W (ethylene bistetrabromophthalimide), Saytex™ 120 (tetradecabromodiphenoxy benzene), Saytex™ 102 (decabromodiphenyl oxide), and Saytex™ 8010 (ethylene-1,2-bis(pentabromophenyl). The flame retardant can be used in combination with a synergist, for example, a halogenated flame retardant can be used in combination with a synergist such as antimony trioxide, and a phosphorus-containing flame retardant can be used in combination with a nitrogen-containing compound such as melamine. A further example of an organic flame retardant includes hydrocarbons with tertiary carbons that can form stable radicals.

The curable composition can further optionally include an additive composition including one or more additives with the proviso that the presence of the addition composition does not significantly adversely affect a desired property of the curable composition. The additive composition can include an antioxidant, a silane, or a combination thereof.

Antioxidant additives can include, for example, organophosphites such as tris(nonyl phenyl)phosphite, tris(2,4-di-t-butylphenyl)phosphite, bis(2,4-di-t-butylphenyl)pentaerythritol diphosphate, distearyl pentaerythritol diphosphate; alkylated monophenols or polyphenols; alkylated reaction products of polyphenols with dienes, such as tetrakis[methylene(3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or a combination thereof. The antioxidant can be present in the curable composition in an amount of 0 to 0.3 weight percent, based on the dry weight of the curable composition.

The curable composition can further include the antioxidant in an amount of greater than 0 to 2 weight percent, or greater than 0 to 1 weight percent, or greater than 0 to 0.6 weight percent, based on the total weight of dry components of the curable composition.

Silanes can function as coupling agents to promote the formation of or participate in covalent bonds that improve adhesion between the filler and the polymer components of the curable composition. Exemplary silane coupling agents can include vinyltrichlorosilane, vinyltrimethoxysilane, trivinylmethoxysilane, vinyltriethoxysilane, vinyltris(β-methoxyethoxy)silane, ß3-(3,4-epoxycyclohexyl)ethyltrimethoxysilane, γ-glycidoxypropyltrimethoxysilane, γ-glycidoxypropylmethyldiethoxysilane, γ-glycidoxypropyltriethoxysilane, γ-methacryloxypropylmethyldimethoxysilane, γ-methacryloxypropyltrimethoxysilane, γ-methacryloxypropylmethyldiethoxysilane, γ-methacryloxypropyltriethoxysilane, N-ß(aminoethyl)γ-aminopropylmethyldimethoxysilane, N-ß(aminoethyl)γ-aminopropyltrimethoxysilane, bis(trimethoxysilylethyl)benzene, bis(triethoxysilyl)ethylene, triethoxysilyl-modified butadiene, styrylethyltrimethyloxysilane, N-ß(aminoethyl)γ-aminopropyltriethoxysilane, γ-aminopropyltrimethoxysilane, γ-aminopropyltriethoxysilane, N-phenyl-γ-aminopropyltrimethoxysilane, trimethoxyphenylsilane, perfluorocotyltriethoxysilane, γ-mercaptopropyltrimethoxysilane, and octylvinyl trimethoxy silane. The silane can be present in the curable composition in an amount of 0 to 1.5 weight percent, based on the dry weight of the curable composition.

The curable composition can further include the silane in an amount of greater than 0 to 4 weight percent, or greater than 0 to 1 weight percent, based on the total weight of dry components of the curable composition.

Each A block of the hydrogenated block copolymer can be derived from para-methylstyrene; each B block of the hydrogenated block copolymer can be a copolymer derived from para-methylstyrene and a conjugated diene of isoprene, butadiene, or a combination thereof, wherein the B block can have a conjugated diene content of 10 to 55%; wherein each A block can have a peak molecular weight of 3 to 60 kg/mol and each B block can have a peak molecular weight of 20 to 200 kg/mol. The filler can includes silica.

The curable composition can be formed by combining the various components, in any order, optionally in the melt or in an inert solvent. The combining can be by any suitable method, such as blending, mixing, or stirring. The components used to form the curable composition can be combined by dissolving or suspending the component in a solvent to provide a coating solution.

Also provided is a varnish including the curable composition disclosed herein and a solvent. The solvent can be selected so as to dissolve the components of the curable composition, disperse particulate additives and any other optional additives that can be present, and to have a convenient evaporation rate for forming, drying, and b-staging. The solvent can include, for example, at least one of xylene, toluene, methyl ethyl ketone (MEK), methyl isobutyl ketone (MIBK), hexane, a higher liquid linear alkane (for example, heptane, octane, or nonane), cyclohexane, cyclohexanone, isophorone, glycol ether PM, glycol ether PM acetate, or a terpene-based solvent. The solvent can include at least one of xylene, toluene, methyl ethyl ketone, methyl isobutyl ketone or hexane. The solvent can include at least one of xylene or toluene. The solvent can be present in an amount of 2 to 20 weight percent, or 2 to 10 weight percent, or 2 to 5 weight percent based on the total weight of the varnish. The varnish can include 80 to 98 weight percent solids (all components other than the solvent), or 15 to 40 weight percent solids, based on the total weight of the varnish. The solvent can be present in an amount of 10 to 50 weight percent, or 15 to 45 weight percent, or 20 to 40 weight percent based on the total weight of the varnish.

The curable compositions and varnishes disclosed herein can be used for the preparation of cured compositions. The cured composition can be in the form of a film, for example having a thickness of 10 to 100 micrometers. For example, a build-up film can have a thickness of 10 to 100 micrometers. The cured composition can be in the form of a film, for example having a thickness of 10 to 130 micrometers. For example, a bondply can have a thickness of 50 to 130 micrometers.

The cured composition can also be a composite laminate wherein the cured composition is in contact with a reinforcing layer. The reinforcing layer can include a fabric, for example a fibrous layer including a plurality of thermally stable fibers. The fabric can be woven or non-woven. The fabric can reduce shrinkage of the composite upon cure within the plane of the composite. In addition, the use of the fabric can help render the composite with a relatively high dimensional stability and mechanical strength (modulus). Such materials can be more readily processed by methods in commercial use, for example, lamination, including roll-to-roll lamination. The thermally stable fibers can include glass fibers such as at least one of E glass fibers, S glass fibers, D glass fibers, or lower dielectric constant, lower dissipation loss fibers such as L glass fibers or quartz fibers. For example, lower dielectric constant, lower dissipation factor, thermally stable fibers such as NITTOBO NE or NER commercially available from Nitto Boseki Co., Ltd. Of Tokyo, Japan or L-Glass™ fiber or L2-Glass™ fiber, each commercially available from AGY, Aiken, South Carolina are contemplated for the present disclosure.

Thermally stable fabrics including glass fibers can be plain weave or spread-weave and can be balanced. Spread-weaves can enhance impedance control, resistance to conductive anodic filament (CAF) growth, dimensional stability, prepreg yields and can be more amenable to laser drilling during circuit fabrication. The fabric can include a lower dielectric constant, lower dissipation factor spread-weave fabric in an amount of 5 to 40 weight percent, or 15 to 25 weight percent based on the total weight of the composite.

The method for treating the reinforcing layer with the curable composition is not limited and can be performed, for example, by dip coating or roll coating, optionally at an increased temperature. A single ply composite can have a thickness of 10 to 200 micrometers, or 30 to 150 micrometers. Two or more plies can be laminated together to form a multilayer composite material.

Lamination and optional curing can be by a one-step process, for example, using a vacuum press, or can be by a multi-step process. In a one-step process, the layered structure can be placed in a press, brought to a laminating pressure and heated to a laminating temperature. The laminating temperature can be 100 to 390 degrees Celsius (° C.), or 100 to 250° C., or 100 to 240° C., or 100 to 230° C., or 150 to 220° C., or 170 to 210° C. The laminating pressure can be 1 to 3 megapascal (MPa), or 1 to 2 MPa, or 1 to 1.5 MPa. The laminating temperature and pressure can be maintained for a desired dwell (soak) time, for example, 5 to 150 minutes, or 5 to 100 minutes, or 10 to 50 minutes, and thereafter cooled, at a controlled cooling rate (with or without applied pressure), for example, to less than or equal to 150° C.

A prepreg, a build-up film, a bondply, a resin-coated electrically conductive layer, or a cover film can include the composite. The composite can be a non-clad or declad dielectric layer, a single clad dielectric layer, or a double clad dielectric layer. A double clad laminate has two electrically conductive layers, one on each side of the composite. A circuit material can include the composite. The circuit material is a type of circuit subassembly that has an electrically conductive layer, for example, copper, fixedly attached to a composite. Patterning the electrically conductive layer, for example by printing and etching, can provide the circuit. A multilayer circuit can include a plurality of electrically conductive layers, at least one of which contains an electrically conductive wiring pattern. Multilayer circuits can be formed by laminating two or more materials in proper alignment together, at least one of which contains a circuit layer, using bondplies, while applying heat or pressure.

The cured composition can exhibit one or more desirable properties. For example, the cured composition can exhibit a dissipation factor (Df) of 0.0006 to 0.005, or 0.0008 to 0.005, or 0.001 to 0.005, or 0.001 to 0.003, or 0.001 to 0.0025, or 0.001 to 0.002, or 0.0006 to 0.002, at 10 gigahertz (GHz). The cured composition can exhibit a dielectric constant (Dk) of 2.9 to 3.4 at 10 GHz. Desirably, the Dk is within +/−0.1 of the Dk of the copper clad laminate. The cured composition can exhibit a CTE of less than or equal to 40 ppm/° C., or 5 to 40 ppm/° C., or 5 to 30 ppm/° C., 5 to 20 ppm/° C., or 3 to 20 ppm/° C., measured with thermomechanical analysis (TMA) over a temperature range of −40 and 140° C. The cured composition can exhibit a dielectric constant (Dk) of 2.5 to 3.4 or 2.5 to 2.9 at 10 GHz. The cured composition can exhibit a dissipation factor (Df) of less than 0.0014, at 10 GHz. For example, the cured composition can exhibit a dissipation factor (Df) of 0.0005 to 0.0014, at 10 GHz.

The cured composition can have a peel strength from copper of 0.5 to 5.5 pounds per linear inch (pli) (87.6 to 963.2 newtons per meter (N/m)), or 1 to 5 pli (175.1 to 875.6 N/m). The cured composition can exhibit a UL94 V0 rating at a thickness of 84 to 760 micrometers determined in accordance with the Underwriter's Laboratory UL 94 Standard For Safety “Tests for Flammability of Plastic Materials for Parts in Devices and Appliances.”

Desired are copper clad laminates having similar electrical and mechanical properties to PTFE based dielectric materials, for example, Dk equal to 3.0 with low Df (<0.002), and very low insertion loss properties (e.g., −1.3 decibels per inch (dB/in) at 77 gigahertz (Ghz) (+/−10%)). Copper clad laminates can have good bond properties to very smooth copper foils (e.g., less than 0.25 μm average roughness (Sa), less than 0.31 μm root mean square roughness (Sq), and less than 2.63 μm peak to valley height (Sz)), with only minor changes to electrical properties with heat and humidity storage (e.g., Dk change from 3.13 to 3.21 and Df change of less than a factor of about 2 from about 0.0015 to about 0.003 after 90 days of 140° C. conditioning). Copper clad laminates can have good lay-flat properties (no curl) and can be non-tacky, demonstrated by acceptable release from release liners when dried but not cured. The copper clad laminates exhibit good dimensional stability properties with one side etched laminates and low CTE even though not glass reinforced. Copper clad laminate products are useful in single layer designed products but bondply materials are desired for copper clad laminate products to be useful in multilayer laminate products. The copper clad laminate can have a low insertion loss of less than −1.3 dB/in, for example, −1.0 dB/in, at 77 GHz (+/−10%)).

Bondplies can be used with cores of the clad laminates to make multilayer laminates. The bondply can include, for example, consist of, the cured composition.

Desired is a CTE in the x/y direction between −40 and 140° C. as close to 18 as possible to avoid stress building up between the dielectric and the copper foil, which has a CTE of about 17-18. High stress can lead to premature failure, panel warpage, or a combination thereof. If the CTE is within about 10 ppm/° C., stress should not be apparent in a finished article.

The molecular weight of the second crosslinkable component is relatively low since the second crosslinkable component is a liquid. Being a liquid at room temperature allows the curable composition some flexibility to lay-flat (i.e., no curl) when dried, which can enable handle-ability laying up the product prior to cure. The vinyl groups of the second crosslinkable component provide reactivity to the second crosslinkable component.

Inclusion and the amount of the second crosslinkable component in a curable composition can provide the curable composition same with an improved (e.g., lower) CTE. The second crosslinkable component can improve flow properties of a curable composition including same, which can be important for bondply applications.

A weight ratio of the first crosslinkable component to the second crosslinkable component can be in a range of 0.6:1 to 2:1 or 0.727:1 to 1.96:1. Adjustment of the weight ratio of the first crosslinkable component to the second crosslinkable component can affect properties of a curable composition including the same, such as, flow. Adjustment of the weight ratio of the first crosslinkable component to the second crosslinkable component can affect properties of a dried curable composition including the same, such as, tackiness or releasability from a carrier or liner, flexibility, CTE, or a combination thereof.

In contrast to the disclosed second crosslinkable component, a polymer that includes unsaturation in the backbone thereof may not fully react even after crosslinking, and a final product may not be stable electrically over time. For example, the Df of a composition including a polymer that includes unsaturation in the backbone thereof can increase with heat, or humidity, or a combination thereof exposure over time.

Provided is a curable composition with a low CTE film that is not supported with glass that has low Dk and very low Df. The cured composition can exhibit electrical thermal stability or only minor changes with heat aging, for example, little or no change in Dk (e.g., less than 0.02 from 3.13 to 3.15) after about 500 hours and only minor changes (e.g., less than 0.0005 from about 0.0015 to about 0.002) in Df. The cured composition can exhibit a dissipation factor (Df) of less than 0.0014.

The curable composition can include 4.9 to 12 weight percent of a hydrogenated block copolymer including at least one A block and at least one B block, wherein prior to hydrogenation, each A block is a polymer of a first vinyl aromatic compound, and each B block is a copolymer of a second vinyl aromatic compound, a conjugated diene, and optionally a third vinyl aromatic compound; 5 to 11 weight percent of a first crosslinkable component including a polymeric reactive diluent having a glass transition temperature of greater than or equal to 100° C. and at least one crosslinkable reactive group; and 5 to 11 weight percent of a second crosslinkable component including a polyaromatic vinyl compound; wherein weight percent of each component is based on a total weight of dry components of the curable composition; and wherein the curable composition further includes 36 to 51 volume percent of a filler wherein volume percent of the filler is based on a total volume of dry components of the curable composition.

A bondply can include a composite laminate including the disclosed cured composition. The cured composition can be in the form of a film, and the cured composition may not be in contact with a reinforcing layer, for example, a glass fiber reinforcing layer. A build-up film can include the disclosed cured composition. The cured composition may not be in contact with a reinforcing layer, for example, a glass fiber reinforcing layer.

This disclosure is further illustrated by the following examples, which are non-limiting.

### Examples

Materials used in the following Examples are provided in Table 1.

TABLE 1

| Component | Chemical Description | Tradename | Supplier |
|---|---|---|---|
| SBC1 | Hydrogenated styrenic block copolymer | MD3501 | Kraton |
| | having a styrene content of 45-55% and | | |
| | a weight average molecular weight of | | |
| | 110,000-130,000 grams per mole | | |
| SBC2 | Same polymer as SBC1 but at a lower | KICS BM-010 | Kraton |
| | MW | | |
| SBC3 | Same polymer as SBC2 but at a lower | KICS BM-020 | Kraton |
| | MW | | |
| CC1 | Polymer having crosslinkable reactive | ELPAC HC-G0024 | JSR |
| | groups | | |
| CC2 | Crosslinkable polyaromatic vinyl | STR-2000-60ST | Nippon Kayaku |
| | compound | | |
| Functionalized PBD | Polymer with some phosphorus-based | BO1001 | Nisso |
| | functionality | | |
| FR1 | Ethylene-1,2-bis(pentabromophenyl) | SAYTEX 8010 | Ablemarle |
| | flame retardant | | |
| FR2 | Phosphorus and nitrogen-based | FP-72 | Fushimi |
| | halogen-free flame retardant | | |
| FR3 | Phosphorus and nitrogen-based, | LF-4 | Polyrock |
| | halogen-free flame retardant | | Chemical Co. |
| FR4 | Phosphorus-based, halogen-free flame | PQ-60 | DKS |
| | retardant | | |
| FR5 | Phosphorus and nitrogen containing | FR2020 | Donghua |
| | flame retardant | | |
| Silane | 7-Octenyltrimethoxysilane | KBM 1083 | Shin-Etsu |
| Antioxidant | Oligomeric hindered amine stabilizer | CHIMASSORB 944 LD | BASF |
| Filler1 | Fused solid spherical vinyl treated | FB8C | Denka |
| | silica; D50 of 8 micrometers (μm) | | |
| Filler2 | Microspherical silica; D50 of about 2 | RESIFA ™ | AGC Chemicals |
| | μm | SOLESPHERE ™ HS-200 | Americas |
| Filler3 | Hollow soda-lime-borosilicate glass | Glass Bubbles S32HS | 3M |
| | microspheres; D50 of about 25 μm | | |
| Filler4 | spherical silica; D50 = 8.0 μm; | EQM8015-SMC (white) | Zhejiang Third |
| | D100 = 15 μm; Specific Surface Area | | Age Materials |
| | (SSA) = 0.4 m²/g; | | Technology |
| | methacrylate silane treatment | | |
| Filler5 | spherical silica; D50 = 8 μm; | EQM8015-SIV (white) | Zhejiang Third |
| | D100 = 15 μm; SSA = 0.4 m²/g; | | Age Materials |
| | chain extended vinyl silane treatment | | Technology |
| Filler6 | spherical silica; D50 = 8 μm; | DQM8015-SBV (black) | Zhejiang Third |
| | D100 = 15 μm; SSA = 0.4 m²/g; | | Age Materials |
| | vinyl silane treatment | | Technology |
| Filler7 | spherical silica; D50 = 5 μm; | EQM5010-SBV | Zhejiang Third |
| | D100 = 10 μm; SSA = 0.6 m²/g; | | Age Materials |
| | vinyl silane treatment | | Technology |
| Filler8 | spherical silica; D50 = 5 μm; | EQM5010-SIV | Zhejiang Third |
| | D100 = 10 μm; SSA = 0.6 m²/g; | | Age Materials |
| | chain extended vinyl silane treatment | | Technology |
| Filler9 | spherical silica; D50 = 8 μm; | EQM8015-SBV (white) | Zhejiang Third |
| | D100 = 15 μm; SSA = 0.4 m²/g; | | Age Materials |
| | vinyl silane treatment | | Technology |
| Filler10 | spherical silica; D50 = 8 μm; | GT8C | Denka |
| | D100 = 50 μm; SSA = 1.5 m²/g | | |
| | not silane treated | | |
| Filler11 | spherical silica; D50 = 2.04 μm; | S36080VA | Novaray |
| | D100 = 15 μm; vinyl silane treatment | | |
| Filler12 | spherical silica; D50 = 8 μm; | GT8C vinyl treated | Denka |
| | D100 = 50 μm; SSA = 1.5 m²/g; | | |
| | vinyl silane treatment | | |
| Filler13 | spherical silica; D50 = 10.1 μm; | Sample G | Denka |
| | not silane treated | | |
| Filler14 | Spherical silica filler; D50 = 0.6 μm; | TAT-0610 | Zhejiang |
| | D100 = 10 μm; SSA = 5.5 m²/g; | | Third Age |
| | vinyl-functional surface treatment | | Material |
| | | | Technology |
| Filler15 | Spherical silica filler with phenylamino- | S56S80 | NOVORAY |
| | functional surface treatment | | |
| Initiator1 | Peroxide | VulCup | |
| Initiator2 | Peroxide | Di-cup | Sigma Aldrich |

Curable compositions were prepared according to the following general procedure. Polymeric components were blended in a toluene solution. Filler and other additives were then blended under shear with the polymeric components to provide a varnish.

Varnishes including the curable compositions were cast onto a polymeric carrier and laminated to a copper foil (HVLP3 roughness rating, 0.09 μm average roughness (Sa), 0.12 μm root mean square roughness (Sq), and 1.31 μm peak to valley height (Sz))) using a press cycle with a ramp rate of 7° F. per minute to a maximum temperature of 400° F. (204.44° C.) for 60 minutes at 400 pounds per square inch (psi) (2.76 megapascals (MPa)).

Properties of the resulting films were characterized according to the following test methods. Melt rheology of the cast film (no foil) was characterized using an ATD3000 oscillating parallel plate rheometer (Alpha Technologies). Dielectric constant (Dk) and dissipation factor (Df) were measured at 10 GHz using a split post dielectric resonator. Copper adhesion was tested according to IPC™-650 2.4.8.1. The puck generated from the ATD3000 oscillating parallel plate rheometer (also referred to herein as “ATD puck”) was used to measure CTE.

Examples 1-6 are summarized in Table 2. All percentages are weight percent, unless indicated otherwise.

Curl and flex are rated on a scale of 1 (good) to 5 (bad). The ratings are qualitative, comparative assessments. A curl rating of 1 is lay-flat, a curl rating of 3 exhibits edges rolling up, and with a curl rating of 5, the whole coupon will roll up into a tube. For flex, the coupon is bent over on itself. A flex rating of 1 means no breakage, a flex rating of 3 means some breakage, and a flex rating of 5 indicates breakage or cracking.

TABLE 2

| | Example 1 | Example 2 | Example 3 | Example 4 | Example 5 | Example 6 |
|---|---|---|---|---|---|---|
| SBC1 | 8.30% | 8.83% | 8.80% | 8.70% | 8.40% | 8.38% |
| CC1 | 2.77% | 3.31% | 4.62% | 6.52% | 7.80% | 7.78% |
| CC2 | 11.07% | 9.93% | 8.58% | 7.97% | 7.80% | 7.78% |
| FR1 | 8.86% | 8.83% | 8.80% | 9.28% | 9.60% | 9.57% |
| Silane | 0.50% | 0.50% | 0.50% | 0.53% | 0.50% | 0.50% |
| Antioxidant | 0.22% | 0.22% | 0.22% | 0.23% | 0.00% | 0.24% |
| Filler1 | 66.87% | 66.96% | 67.09% | 65.28% | 64.41% | 64.80% |
| Filler2 | 1.20% | 1.19% | 1.19% | 1.25% | 1.25% | — |
| Filler3 | — | — | — | — | — | 0.72% |
| Initiator 1 | 0.22% | 0.22% | 0.22% | 0.23% | 0.24% | 0.24% |
| CC1:CC2 | 0.250:1 | 0.333:1 | 0.538:1 | 0.818:1 | 1:1 | 1:1 |
| Filler Volume Percent | 55 | 55 | 55 | 53 | 52 | 52 |
| Filler + FR Volume Percent | 59.60 | 59.58 | 59.56 | 57.73 | 56.87 | 56.83 |
| Solid/Hollow Volume | 93:7 | 93:7 | 93:7 | 93:7 | 93:7 | 93:7 |
| Ratio | | | | | | |
| Comment | | | release from | improved | good flow, | good flow, |
| | | | carrier not | flow, | acceptable | acceptable |
| | | | acceptable | acceptable | release | release |
| | | | | release | from | from |
| | | | | from | carrier | carrier |
| | | | | carrier | | |
| SPDR 10 GHz | | | | | | |
| Thickness of the tested | too tacky to | too tacky to | 0.0089 | 0.0197 | 0.0186 | 0.0148 |
| laminate (in) | remove from | remove from | | | | |
| Thickness of the tested | carrier | carrier | 226.1 | 500.4 | 472.4 | 375.9 |
| laminate (μm) | | | | | | |
| Dk | | | 2.95 | 3.06 | 3.13 | 3.04 |
| Df | | | 0.0015 | 0.0015 | 0.0015 | 0.0016 |
| Bond to Cu Foil | | | | | | |
| 15-20 mil Bond (pounds | no data | no data | 2.77 | 2.5 | 3.00 | 2.94 |
| per lineal inch (pli)) | | | | | | |
| 15-20 mil Bond | | | 485.1 | 437.8 | 525.4 | 514.9 |
| (newtons per meter | | | | | | |
| (N/m)) | | | | | | |
| 10 days at 140° C. (pli) | | | 2.6 | 2.57 | 2.85 | 2.79 |
| 10 days at 140° C. (N/m) | | | 455.3 | 450.1 | 499.1 | 488.6 |
| Curl | 1.5 | 1.5 | 1.5 | 1 | 1.5 | 1 |
| Flex | 1 | 1 | 1 | 1 | 1 | 1 |
| CTE-Z ATD puck | | | | | | |
| (ppm/° C.) | | | | | | |
| −40 to 140° C. | 30 | 25 | 24 | 27 | 23 | 23 |
| 50 to 150° C. | 32 | 24 | 24 | 28 | 23 | 23 |
| 150 to 250° C. | 52 | 50 | 47 | 48 | 46 | 48 |
| −55 to 288° C. | 37 | 32 | 33 | 34 | 31 | 33 |
| CTE-XY ATD puck | | | | | | |
| (ppm/° C.) | | | | | | |
| −40 to 140° C. | 29 | 25 | 25 | 28 | 25 | 24 |
| 50 to 150° C. | 30 | 26 | 26 | 30 | 26 | 23 |
| 150 to 250° C. | 55 | 53 | 58 | 62 | 62 | 65 |
| −55 to 288° C. | 38 | 34 | 37 | 40 | 38 | 37 |
| ATD Viscosity (Poise) | | | | | | |
| Initial (Curable) | 5.2E+06 | 2.9E+07 | 2.5E+07 | 2.3E+07 | 2.8E+07 | 3.2E+07 |
| Minimum | 1.5E+05 | 8.7E+04 | 4.8E+04 | 6.6E+04 | 1.2E+05 | 5.0E+04 |
| Final (Cured) | 9.7E+07 | 9.8E+07 | 1.1E+08 | 8.7E+07 | 9.6E+07 | 9.9E+07 |

Example 1 was too tacky for practical use. The ratio of CC1:CC2 was evaluated. In Example 1, the ratio of CC1:CC2 was 0.250:1. Examples 2 and 3 evaluated increasing the ratio of CC1:CC2 to 0.333:1 and 0.538:1, respectively, and adjusting the SBC1 from 35 to 45 parts per hundred resin (phr). Examples 2 and 3 exhibit high tack and tight (e.g., unacceptable) release making them unsuitable for use as a bondply. The conclusion reached was that the ratio of CC1:CC2 was still too low for practical usage.

Example 4 further increased the CC2 addition level and adjusted the ratio of CC1:CC2 to 0.818:1. Example 4 did not curl and was flexible when dried with relatively low CTE. Example 5 had a ratio of CC1:CC2 of 1:1. A bond of about 3 pounds per lineal inch (pli) (525 newtons per meter (N/m)), which should be suitable for inner layer adhesion in multilayer laminates, is desirable.

The films of Examples 1 and 2 have desirable flow properties, low CTE, electrical properties that match a copper clad laminates (CCL) core, and good bond properties to copper foil and dielectric materials, and can enable the manufacture of multilayer laminates. As compared to Example 5, in Example 6 Filler3 was substituted for Filler2. Filler3 is less expensive and has a larger D50 particle size. Flow properties were improved and varnish mixing was more homogenous. The formulation of Example 6 was slightly altered to adjust for the different specific gravity of Filler3 versus Filler2.

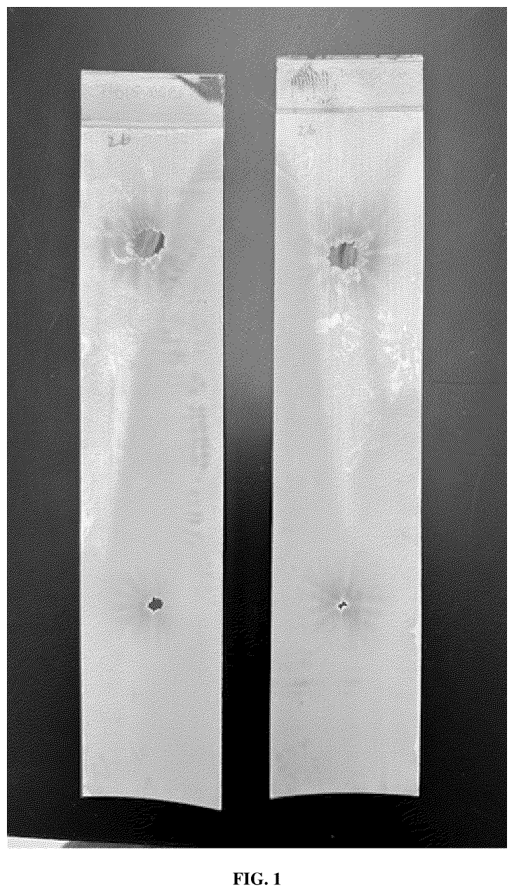

Flow properties were evaluated using a hole punch method. Holes of diameter 0.375 inches (0.95 centimeters (cm); top punch in FIGS. 1-5) and 0.75 inches (1.91 cm; bottom punch in FIGS. 1-5) were punched around the perimeter and in the center of a prepreg prior to lamination. The areas that were punched are taped on one side of the laminate (to prevent the copper from being etched off), and the opposite side copper foil is completely etched. The areas that were punched were then inspected for flow. Flow was rated two ways. One is the degree of filling the hole. Flow will occur with the laminated prepreg prior to curing. The amount of flow to fill the punched holes was evaluated. The samples were comparatively evaluated and rank the amount of fill was ranked among the samples. The holes were also evaluated to determine whether the holes were filled with both polymer and filler. With fill of polymer and filler, Dk will stay the same. Flow of only one is less desirable.

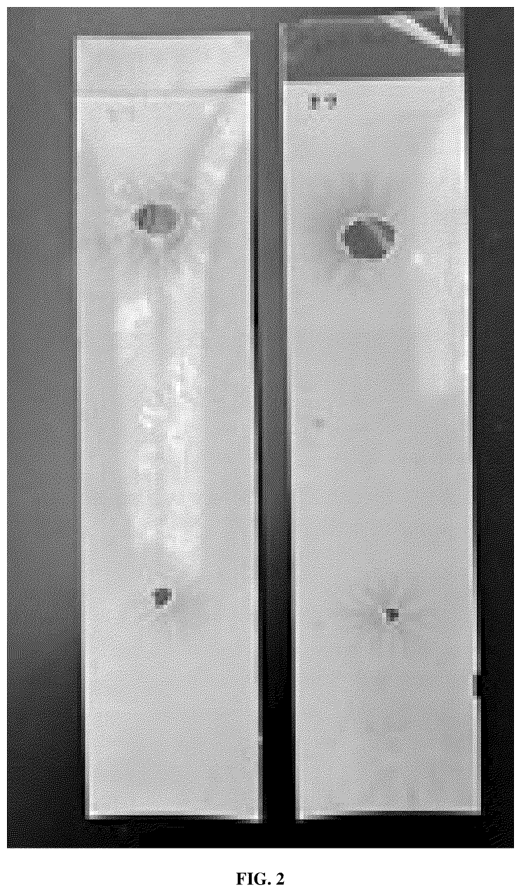

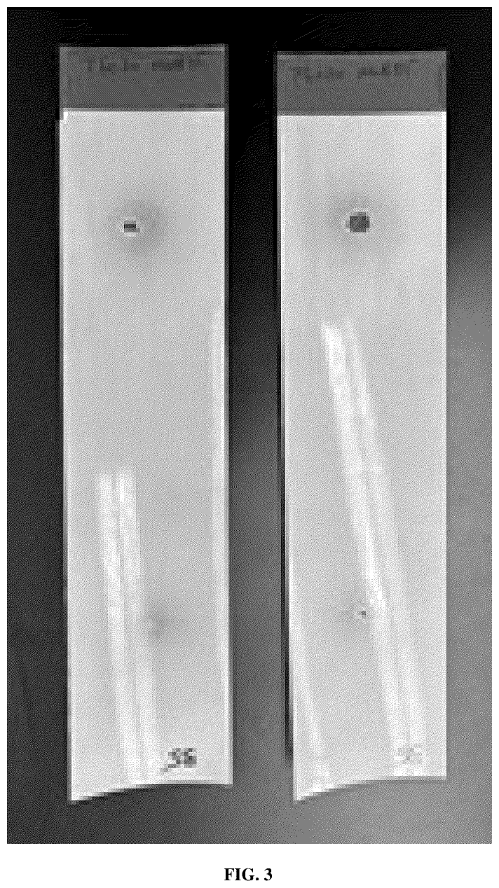

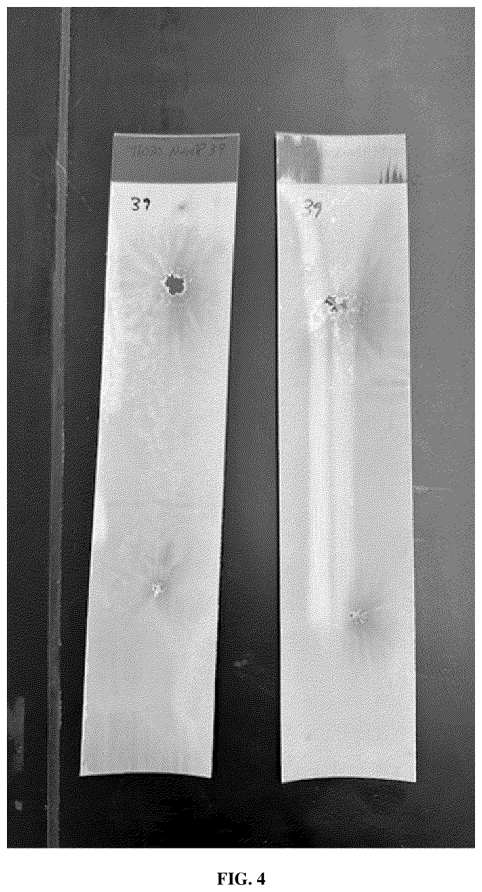

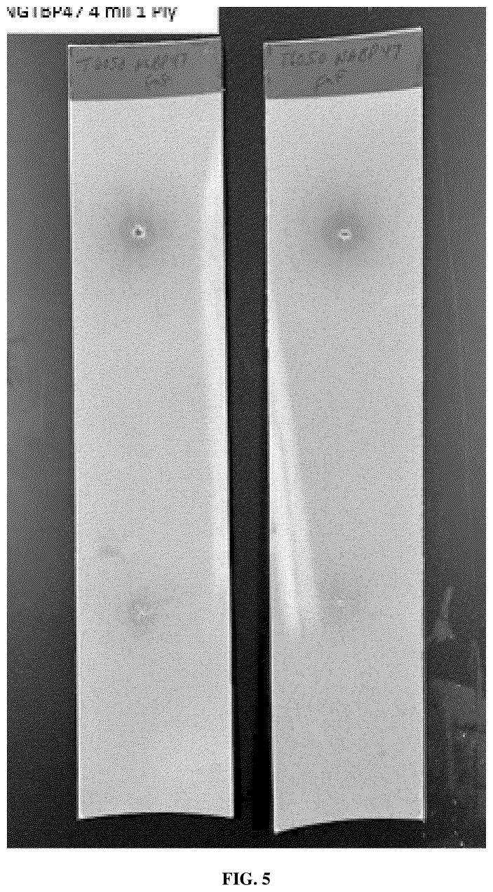

Example 1 was too tacky to perform flow testing, results of Example 2 (CC1:CC2=0.333:1) can be seen in FIG. 1, results of Example 6 (CC1:CC2=0.538:1) can be seen in FIG. 2, results of Example 4 (CC1:CC2=0.818:1) can be seen in FIG. 3, results of Example 5 (CC1:CC2=1:1) can be seen in FIG. 4, and results of Example 6 (CC1:CC2=1:1) can be seen in FIG. 5. In FIG. 1, both the small and large holes are not filled (tape on the backside of the laminate can be seen through the holes). There is some flow but it is low. Without wishing to be bound by any theory, it is believed that the ratio of CC1 to CC2 affects how much fill and flow is apparent. The results shown in FIG. 2 are comparable to the results shown in FIG. 1.

In FIG. 3, better flow can be seen compared to FIG. 1 and FIG. 2, as the 0.375 inch (0.95 cm) holes are almost filled. In FIG. 4, the flow for 0.375 inch (0.95 cm) holes is improved compared to FIG. 3, and the 0.75 inch (1.91 cm) holes are also improved (the tape on the backside of the laminate is less visible through the hole). FIG. 5 shows a big improvement, in that both the small and large holes are completely filled. In Example 5, acceptable release from the carrier film and low curl and flex in the uncured state are exhibited. Example 5 exhibits desirable uncured and cured properties.

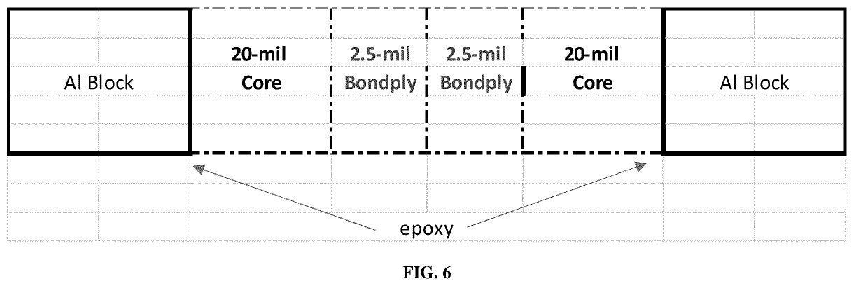

Cross ply tensile testing was also conducted to evaluate whether the film (also referred to herein with reference to the following examples as a “bondply”) would adhere to a core material. The core used included SBC1, CC1, FR1, Silane, Antioxidant, Filler3, Initiator1, and solid silica having a D50 of 2.5 μm. A 20-mil (0.51 millimeter (mm)) core was used on both sides of the bondply. The bondply included two plies of 2.5 mil (0.06 mm) dried coating. The bondply was laminated to the core using a ramp rate of 7° F. per minute to a temperature of 350° F. (176.67° C.) at 400 psi (2.76 MPa) and then held at 350° F. (176.67° C.) for 60 minutes, followed by lowering of the temperature. The composite core/bondply/core is then bonded to two aluminum blocks using epoxy. The epoxy is allowed to cure for a minimum of 24 hours, resulting in an article illustrated in FIG. 6.

The article was then pulled apart using an Instron® Universal Testing Machine and the force to separate the core from the bondply was measured. Both the core and the bondply were coated onto a release liner or carrier, and there was an “air” side and a “liner” side to each after drying. The designations “air” side and “liner” side are used herein even after removal of the release liner.

The testing is qualitative to determine failure location and the mechanism of failure to ensure the failure is not adhesive (clean failure at the interface) between the core and the bondply. Without wishing to be bound by any theory, it is believed that failure is induced at a minimum force of about 1,000 psi (6.9 MPa). The minimum force to induce failure could be lower if the failure location is not at the interface of the core and bondply and the failure mode is not adhesive. A force of about 1,500 psi (10.3 MPa) can indicate that the bond between the core and bondply is sufficiently high and the probability of failure at that interface is low.

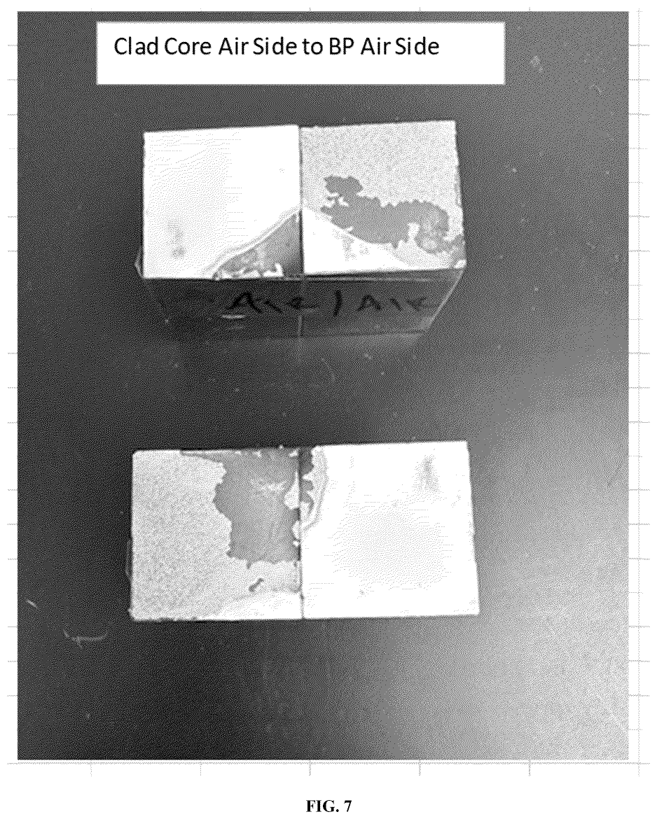

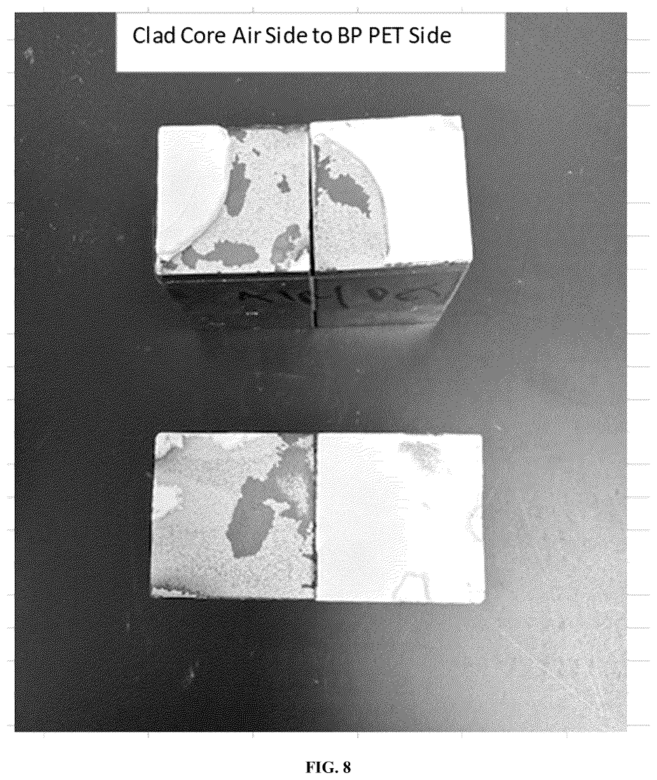

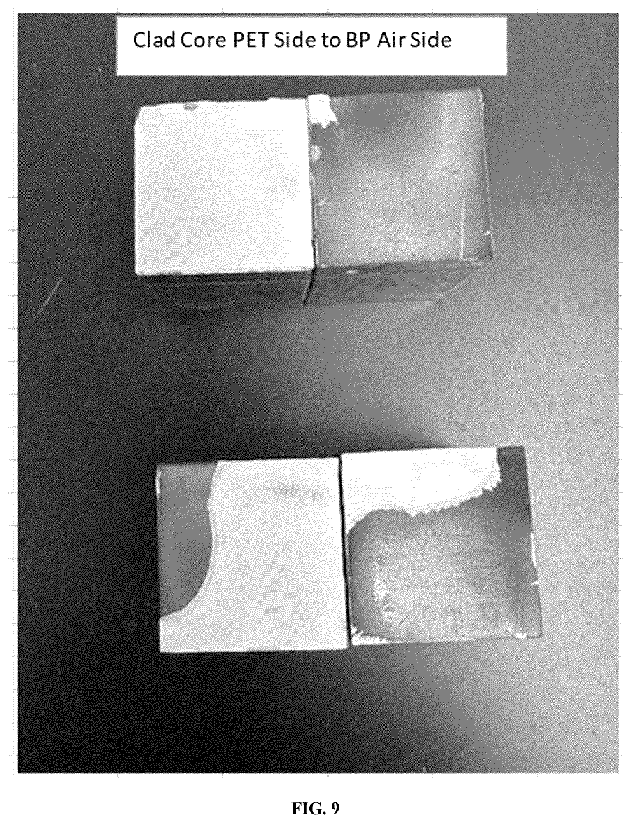

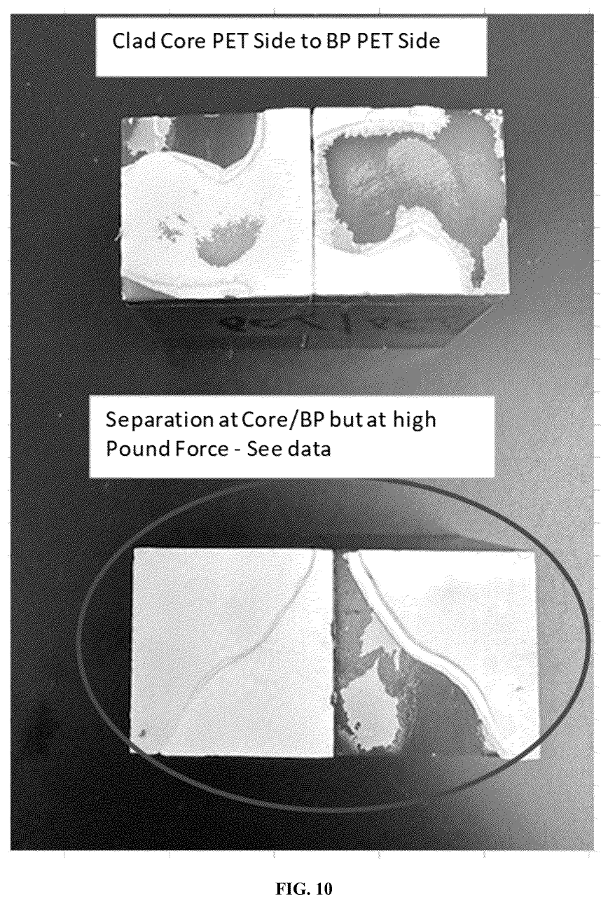

Testing was conducted in duplicate. The results are provided in Table 3 and FIGS. 7-10. FIG. 7 shows results of core air side bonded to bondply air side, FIG. 8 shows results of core air side bonded to bondply liner side, FIG. 9 shows results of core liner side bonded to bondply air side, and FIG. 10 shows results of core liner side bonded to bondply liner side. Cohesive failure was found in the core indicating the bond between the bondply and core is higher than the strength of the core. In one test, the failure was at the epoxy to aluminum block also indicating excellent bond strength between the core and bondply. In one case (bottom of FIG. 10), the separation was between the core and bondply but this was the highest force measured in the samples.

TABLE 3

| | | | | | | | Tensile | |
|---|---|---|---|---|---|---|---|---|
| | | | | | | | stress at | |
| | Bondply | | | | | | Maximum | Tensile stress |
| | sides | Bondply | Core | Core | Maximum | Maximum | Load | at Maximum |
| | facing | side | side | side | load | load | (kilopounds | Load |
| | each | facing | facing | facing | (pound- | (kilogram- | per square | (megapascals |
| FIG. | other | core | bondply | block | force (lbf)) | force (kgf)) | inch (ksi)) | (MPa)) |
| 7 | Liner | Air side | Air side | Liner | 1544.5 | 700.57 | 1.544 | 10.65 |
| | sides | | | sides | 1548.4 | 702.34 | 1.548 | 10.67 |
| 8 | Air sides | Liner | Air side | Liner | 1579.3 | 716.36 | 1.579 | 10.89 |
| | | side | | sides | 1618.5 | 734.14 | 1.619 | 11.16 |
| 9 | Liner | Air side | Liner | Air | 1775.4 | 805.31 | 1.775 | 12.24 |
| | sides | | side | sides | 1678.9 | 761.54 | 1.679 | 11.58 |
| 10 | Air sides | Liner | Liner | Air | 1559.2 | 707.24 | 1.559 | 10.75 |
| | | side | side | sides | 1891.4 | 857.92 | 1.891* | 13.04 |

*Separation at Core-Bondply interface

Further testing was done to evaluate halogen-free flame retardants. Example 7 was a control with no FR and Example 2 was a halogenated control with FR1. Examples 9-11 included FR1 and SBC2 instead of SBC1.

In Examples 11-13, the volume ratio of solid filler to hollow filler was 90:10 to decrease the Dk and SBC2 was used. In Examples 12-13, halogen-free FR2 was used. In Example 13 the filler volume percent was reduced for improved flow properties. Total filler was greater in Example 12 than in Example 13, and the CTE was greater in Example 13 than Example 12.

Desirable characteristics include a minimum viscosity of less than 4.9E+04 and a Df of less than 0.0014.

Tack/release is rated on a scale of 1 (good) to 5 (bad). The ratings are qualitative, comparative assessments. A tack/release rating of 1 means easy release, a tack/release of 3 means tight release, and with a tack/release of 5 means cannot be removed from liner.

TABLE 4

| | Example | Example | Example | Example | Example | Example | Example |
|---|---|---|---|---|---|---|---|
| | 7 | 8 | 9 | 10 | 11 | 12 | 13 |
| SBC1 | 8.65% | 8.38% | | | | | |
| SBC2 | | | 10.96% | 9.79% | 13.37% | 11.88% | 13.98% |
| CC1 | 8.03% | 7.78% | 8.22% | 7.34% | 2.23% | 1.98% | 2.33% |
| CC2 | 8.03% | 7.78% | 8.22% | 7.34% | 6.69% | 5.94% | 6.99% |
| FR1 | | 9.57% | 10.96% | 9.79% | 8.92% | | |
| FR2 | | | | | | 9.90% | 11.65% |
| Silane | 0.51% | 0.50% | 0.5% | 0.5% | 0.50% | 0.50% | 0.50% |
| Antioxidant | 0.25% | 0.24% | 0.27% | 0.24% | 0.22% | 0.20% | 0.23% |
| Filler1 | 73.53% | 64.80% | | | | | |
| Filler2 | | | 1.63% | 1.74% | 1.78% | 1.82% | 1.68% |
| Filler3 | 0.75% | 0.72% | | | | | |
| Filler4/Filler5 blend | | | 58.95% | 63.02% | | | |
| Filler6 | | | | | 64.46% | 67.58% | 62.39% |
| Total Filler (vol %) | 56.8% | 51.7% | 46.71% | 51.16% | 54.0% | 54.0% | 48.0% |
| Solid Filler (vol %) | 53.1% | 48.0% | 42.05% | 46.07% | 48.6% | 48.7% | 43.3% |
| Hollow Filler (vol %) | 3.7% | 3.7% | 4.66% | 5.09% | 5.4% | 5.3% | 4.7% |
| Total Filler + FR (vol %) | 56.8% | 56.5% | 52% | 56%% | 58.6% | 64.7% | 60.1% |
| Initiator | 0.25% | 0.24% | 0.27% | 0.24% | 0.22% | 0.20% | 0.23% |
| Flame Rating (10-mil test coupon) | | | | | 94 V0 | 94 V0 | 94 V0 |
| Flame Rating (20-mil test coupon) | Fail | 94-V0 | | | 94 V0 | 94 V1 | 94 V1 |
| SPDR 10 GHz | | | | | | | |
| # of plies | 3 | 3 | | | | | |
| Laminate Thickness (in) | 0.022 | 0.022 | 0.020 | 0.020 | 0.021 | 0.023 | 0.022 |
| Laminate Thickness (μm) | 558.8 | 558.8 | 508 | 508 | 533.4 | 584.2 | 558.8 |
| Dk | 3.11 | 3.10 | 3.03 | 3.05 | 3.02 | 3.10 | 3.12 |
| Df | 0.0017 | 0.0017 | 0.00119 | 0.00108 | 0.00109 | 0.00169 | 0.00238 |
| Bond to Cu Foil | | | | | | | |
| Air Side (pli) | 3.18 | 3.19 | 3.07 | 2.99 | 3.29 | 2.97 | 2.73 |
| Air Side (N/m) | 556.9 | 558.7 | 537.6 | 523.6 | 576.2 | 520.1 | 478.1 |
| 10 days at 140° C. (pli) | 2.86 | 2.91 | | | | | |
| 10 days at 140° C. (N/m) | 500.9 | 509.6 | | | | | |
| Processability | | | | | | | |
| Curl | 1 | 1 | 1 | 1 | 1 | 1 | 2 |
| Flex | 1 | 1 | 1 | 1 | 1 | 1 | 1 |
| Tack/release | 1 | 1 | 1 | 1 | 2 | 2 | 2 |
| CTE-Z ATD puck (ppm/° C.) | | | | | | | |
| −40 to 140° C. | 21 | 28 | | | | | |
| 50 to 150° C. | 21 | 30 | | | | | |
| 150 to 250° C. | 42 | 50 | | | | | |
| −55 to 288° C. | 28 | 36 | | | | | |
| CTE-XY ATD puck (ppm/° C.) | | | | | | | |
| −40 to 140° C. | 21 | 26 | 37 | 29 | 40 | 35 | 50 |
| 50 to 150° C. | 21 | 28 | 39 | 28 | 47 | 41 | 58 |
| 150 to 250° C. | 60 | 64 | 77 | 75 | 69 | 60 | 74 |
| −55 to 288° C. | 33 | 38 | 50 | 43 | 51 | 45 | 59 |
| ATD Viscosity (Poise) | | | | | | | |
| Initial (Curable) | 4.1E+07 | 4.2E+07 | 3.6E+07 | 4.5E+07 | 2.8E+07 | 4.0E+07 | 2.3E+07 |
| Minimum | 7.5E+04 | 5.9E+04 | 1.9E+04 | 2.9E+04 | 6.5E+04 | 2.5E+05 | 1.2E+05 |
| Final (Cured) | 1.0E+08 | 1.0E+08 | 7.5E+07 | 8.4E+07 | 5.5E+07 | 5.0E+07 | 3.7E+07 |

Further halogen-free flame retardants were evaluated.

TABLE 5

| | Example | Example | Example | Example | Example | Example |
|---|---|---|---|---|---|---|
| | 14 | 15 | 16 | 17 | 18 | 19 |
| SBC1 | 9.23% | 9.23% | 8.90% | 9.62% | 9.87% | 9.07% |
| CC1 | 8.57% | 8.57% | 8.26% | 8.93% | 9.17% | 8.42% |
| CC2 | | 8.57% | 8.26% | 8.93% | 9.17% | 8.42% |
| Functionalized PBD | 8.57% | | | | | |
| FR4 | 15.82% | 10.55% | 10.17% | 16.49% | 21.15% | |
| FR5 | | | | | | 11.66% |
| Silane | 0.49% | 0.55% | 0.50% | 0.51% | 0.50% | 0.50% |
| Antioxidant | 0.26% | 0.26% | 0.25% | 0.27% | 0.28% | 0.26% |
| Filler1 | 56.19% | 61.36% | 62.75% | 54.35% | 49.02% | 60.77% |
| Filler3 | 0.61% | 0.63% | 0.64% | 0.64% | 0.56% | 0.65% |
| Total Filler (vol %) | 39.1% | 44.5% | 45.0% | 38.2% | 33.6% | 43.7% |
| Solid Filler (vol %) | 36.4% | 41.5% | 42.1% | 35.4% | 31.1% | 40.7% |
| Hollow Filler (vol %) | 2.7% | 2.9% | 3.0% | 2.9% | 2.5% | 3.0% |
| Total Filler + FR (vol %) | 56.8% | 56.8% | 56.8% | 56.8% | 56.8% | 58.1% |
| Initiator | 0.26% | 0.26% | 0.25% | 0.27% | 0.28% | 0.26% |
| Flame Rating (10-mil test coupon) | Fail | | Fail | Fail | Fail | |
| Flame Rating (20-mil test coupon) | Fail | Fail | Fail | Fail | Fail | Fail |
| SPDR 10 GHz | | | | | | |
| # of plies | 3 | 3 | 3 | 3 | 3 | |
| Laminate Thickness (in) | 0.024 | 0.018 | 0.026 | 0.017 | 0.021 | 0.0141 |
| Laminate Thickness (μm) | 609.6 | 457.2 | 660.4 | 431.8 | 533.4 | 358.1 |
| Dk | 3.01 | 3.08 | 3.01 | 3.03 | 3.03 | 3.10 |
| Df | 0.0013 | 0.0017 | 0.0014 | 0.0015 | 0.0015 | 0.00154 |
| Bond to Cu Foil | | | | | | |
| Air Side (pli) | 2.25 | 2.46 | 2.32 | 1.99 | 1.84 | 2.54 |
| Air Side (N/m) | 394.0 | 430.8 | 406.3 | 348.5 | 3.22 | 444.8 |
| 10 days at 140° C. (pli) | | 2.18 | | 1.86 | 1.73 | 2.38 |
| 10 days at 140° C. (N/m) | | 381.8 | | 325.7 | 303.0 | 416.8 |
| Processability | | | | | | |
| Curl | 4 | 1 | 4 | 1 | 1 | 1 |
| Flex | 1 | 1 | 1 | 1 | 1 | 2 |
| Tack/release | 1 | 1 | 1 | 1 | 1 | 2 |
| CTE-Z ATD puck (ppm/° C.) | | | | | | |
| −40 to 140° C. | 68 | 35 | 69 | 43 | 46 | |
| 50 to 150° C. | 80 | 38 | 90 | 47 | 51 | |
| 150 to 250° C. | 59 | 50 | 84 | 60 | 63 | |
| −55 to 288° C. | 69 | 41 | 79 | 50 | 54 | |
| CTE-XY ATD puck (ppm/° C.) | | | | | | |
| −40 to 140° C. | 66 | 34 | 66 | 42 | 45 | 35 |
| 50 to 150° C. | 74 | 38 | 78 | 48 | 52 | 39 |
| 150 to 250° C. | 72 | 69 | 79 | 76 | 77 | 69 |
| −55 to 288° C. | 68 | 47 | 71 | 55 | 57 | 46 |
| ATD Viscosity (Poise) | | | | | | |
| Initial (Curable) | 5.8E+07 | 4.2E+07 | 5.7E+07 | 2.8E+07 | 4.2E+07 | 4.2E+07 |
| Minimum | 5.8E+04 | 4.0E+04 | 4.7E+04 | 3.4E+04 | 4.7E+04 | 5.3E+04 |
| Final (Cured) | 6.8E+06 | 1.0E+08 | 8.7E+06 | 9.1E+07 | 9.6E+07 | 1.0E+08 |

Examples 21-23 evaluated FR2 content.

TABLE 6

| | Example 20 | Example 21 | Example 2 | Example 23 |
|---|---|---|---|---|
| SBC1 | 9.04% | 9.04% | 9.16% | 9.26% |
| CC1 | 8.39% | 8.39% | 8.50% | 8.60% |
| CC2 | 8.39% | 8.39% | 8.50% | 8.60% |
| FR2 | 10.33% | 10.33% | 13.08% | 15.88% |
| Silane | 0.004958 | 0.50% | 0.50% | 0.50% |
| Antioxidant | 0.002582 | 0.26% | 0.26% | 0.26% |
| Filler1 | 62.18% | 62.18% | 59.06% | 55.99% |
| Filler3 | 0.65% | 0.65% | 0.66% | 0.64% |
| Total Filler (vol %) | 46.1% | 46.1% | 43.5% | 40.8% |
| Solid Filler (vol %) | 43.0% | 43.0% | 40.4% | 37.8% |
| Hollow Filler (vol %) | 3.1% | 3.1% | 3.1% | 3.0% |
| Total Filler + FR (vol %) | 56.8% | 56.8% | 56.8% | 56.8% |
| Initiator | 0.26% | 0.26% | 0.26% | 0.26% |
| Flame Rating (10-mil test coupon) | 94 V0 | 94 V0 | 94 V0 | 94 V0 |
| Flame Rating (20-mil test coupon) | 94 V1 | 94 V0 | 94 V0 | 94 V0 |
| SPDR 10 GHz | | | | |
| # of plies | 3 | 3 | 3 | 3 |
| Laminate Thickness (in) | 0.017 | 0.0133 | 0.0196 | 0.0206 |
| Laminate Thickness (μm) | 431.8 | 337.8 | 497.8 | 523.2 |
| Dk | 3.03 | 3.13 | 2.97 | 3.04 |
| Df | 0.0016 | 0.0017 | 0.0017 | 0.0017 |
| Bond to Cu Foil | | | | |
| Air Side (pli) | 2.51 | 2.36 | 2.33 | 2.20 |
| Air Side (N/m) | 439.6 | 413.3 | 408.0 | 385.3 |
| 10 days at 140° C. (pli) | 2.31 | 2.30 | 2.30 | 2.10 |
| 10 days at 140° C. (N/m) | 404.5 | 402.8 | 402.8 | 367.8 |
| Processability | | | | |
| Curl | 1 | 1 | 1 | 1 |
| Flex | 1 | 1 | 1 | 1 |
| Tack/release | 1 | 1 | 1 | 1 |
| CTE-Z ATD puck (ppm/° C.) | | | | |
| −40 to 140° C. | 31 | 34 | 38 | 38 |
| 50 to 150° C. | 35 | 39 | 44 | 41 |
| 150 to 250° C. | 46 | 49 | 50 | 48 |
| −55 to 288° C. | 40 | 43 | 46 | 45 |
| CTE-XY ATD puck (ppm/° C.) | | | | |
| −40 to 140° C. | 31 | 33 | 37 | 38 |
| 50 to 150° C. | 34 | 38 | 42 | 43 |
| 150 to 250° C. | 74 | 75 | 72 | 76 |
| −55 to 288° C. | 46 | 48 | 50 | 51 |
| ATD Viscosity (Poise) | | | | |
| Initial (Curable) | 4.3E+07 | 3.9E+07 | 4.7E+07 | 4.2E+07 |
| Minimum | 5.4E+04 | 4.6E+04 | 6.0E+04 | 7.0E+04 |
| Final (Cured) | 8.7E+07 | 8.3E+07 | 7.8E+07 | 7.6E+07 |

In Examples 24-27, the ratio of CC1 to CC2 was adjusted to provide less tack and greater bond strength.

TABLE 7

| | Example 24 | Example 25 | Example 26 | Example 27 |
|---|---|---|---|---|
| SBC1 | 9.10% | 9.06% | 8.38% | 9.07% |
| CC1 | 8.45% | 9.71% | 8.98% | 8.42% |
| CC2 | 8.45% | 7.12% | 6.58% | 8.42% |
| FR1 | | | 9.57% | |
| FR2 | 11.70% | 11.65% | | |
| FR3 | | | | 11.66% |
| Silane | 0.50% | 0.50% | 0.50% | 0.50% |
| Antioxidant | 0.26% | 0.26% | 0.24% | 0.26% |
| Filler1 | 60.64% | 60.80% | 64.80% | 60.77% |
| Filler2 | 0.65% | 0.65% | | |
| Filler3 | 44.8% | 44.9% | 0.72% | 0.65% |
| Total Filler (vol %) | 41.7% | 41.8% | 51.9% | 45.0% |
| Solid Filler (vol %) | 3.1% | 3.1% | 48.2% | 41.9% |
| Hollow Filler (vol %) | 56.8% | 56.8% | 3.7% | 3.1% |
| Total Filler + FR (vol %) | 0.26% | 0.26% | 56.7% | 56.8% |
| Initiator | 0.50% | 0.50% | 0.24% | 0.26% |
| Flame Rating (20-mil test coupon) | 94 V0 | 94 V0 | 94 V0 | 94 V0 |
| SPDR 10 GHz | | | | |
| Laminate Thickness (in) | 0.0213 | 0.0231 | 0.0183 | 0.0237 |
| Laminate Thickness (μm) | 541.0 | 586.7 | 464.8 | 602.0 |
| Dk | 3.14 | 3.12 | 3.14 | 3.09 |
| Df | 0.00157 | 0.00153 | 0.00156 | 0.00207 |
| Bond to Cu Foil | | | | |
| Air Side (pli) | 2.41 | 2.50 | 3.05 | 2.48 |
| Air Side (N/m) | 422.1 | 437.8 | 534.1 | 434.3 |
| 10 days at 140° C. (pli) | 2.11 | 2.31 | 2.65 | 1.85 |
| 10 days at 140° C. (N/m) | 369.5 | 404.5 | 464.1 | 324.0 |
| Processability | | | | |
| Curl | 1 | 2 | 2 | 1 |
| Flex | 2 | 4 | 4 | 2 |
| Tack/release | 2 | 1 | 1 | 2 |
| CTE-XY ATD puck (ppm/° C.) | | | | |
| −40 to 140° C. | 34 | 34 | 26 | 34 |
| 50 to 150° C. | 39 | 37 | 27 | 40 |
| 150 to 250° C. | 73 | 76 | 69 | 75 |
| −55 to 288° C. | 50 | | 40 | 49 |
| ATD Viscosity (Poise) | | | | |
| Initial (Curable) | 5.1E+07 | 7.4E+07 | 7.3E+07 | 3.6E+07 |
| Minimum | 6.5E+04 | 6.5E+04 | 8.3E+04 | 8.0E+04 |
| Final (Cured) | 8.6E+07 | 7.9E+07 | 1.1E+08 | 9.0E+07 |

Examples 28-30 evaluated decreased FR2 content with SBC1.

TABLE 8

| | Example 28 | Example 29 | Example 30 |
|---|---|---|---|
| SBC1 | 9.13% | 9.01% | 8.26% |
| CC1 | 8.48% | 8.36% | 7.67% |
| CC2 | 8.48% | 8.36% | 7.67% |
| FR2 | 7.82% | 5.15% | 9.44% |
| Silane | 0.50% | 0.50% | 0.50% |
| Antioxidant | 0.26% | 0.26% | 0.24% |
| Filler1 | 64.03% | 67.07% | 64.93% |
| Filler3 | 1.04% | 1.03% | 1.05% |
| Total Filler (vol %) | 48.5% | 51.2% | 50.0% |
| Solid Filler (vol %) | 43.6% | 46.3% | 45.0% |
| Hollow Filler (vol %) | 4.9% | 4.9% | 5.0% |
| Total Filler + FR (vol %) | 56.5% | 56.5% | 59.8% |
| Initiator | 0.26% | 0.26% | 0.24% |
| Flame Rating (10-mil test coupon) | 94 V0 | 94 V0 | 94 V0 |
| Flame Rating (20-mil test coupon) | Fail | 94 V1 | 94 V1 |
| SPDR 10 GHz | | | |
| Laminate Thickness (in) | 0.0152 | 0.0185 | 0.0212 |
| Laminate Thickness (μm) | 386.1 | 469.9 | 538.5 |
| Dk | 3.02 | 3.13 | 3.10 |
| Df | 0.00176 | 0.00178 | 0.00171 |
| Bond to Cu Foil | | | |
| Air Side (pli) | 2.77 | 2.76 | 2.54 |
| Air Side (N/m) | 485.1 | 483.4 | 444.8 |
| Processability | | | |
| Curl | 1 | 1 | 1 |
| Flex | 2 | 2 | 2 |
| Tack/release | 2 | 2 | 2 |
| CTE-XY ATD puck (ppm/° C.) | | | |
| −40 to 140° C. | 29 | 28 | 27 |
| 50 to 150° C. | 32 | 30 | 30 |
| 150 to 250° C. | 69 | 69 | 58 |
| −55 to 288° C. | 43 | 42 | 39 |
| ATD Viscosity (Poise) | | | |
| Initial (Curable) | 2.9E+07 | 4.4E+07 | 4.2E+07 |
| Minimum | 3.6E+04 | 7.0E+04 | 9.4E+04 |
| Final (Cured) | 8.9E+07 | 9.1E+07 | 8.6E+07 |

Examples 31-34 evaluated increased content of SBC1. SBC1 is a flammable polymer component limiting an amount that may be used. In addition, SBC1 has poor flow compared to SBC2.

TABLE 9

| | Example 31 | Example 32 | Example 33 | Example 34 |
|---|---|---|---|---|
| SBC1 | 10.33% | 11.63% | 12.92% | 10.04% |
| CC1 | 6.46% | 5.17% | 3.88% | 6.27% |
| CC2 | 9.04% | 9.04% | 9.04% | 8.78% |
| FR2 | 6.46% | 6.46% | 6.46% | |
| Silane | 0.50% | 0.50% | 0.50% | 0.50% |
| Antioxidant | 0.26% | 0.26% | 0.26% | 0.25% |
| Filler1 | 64.83% | 64.83% | 64.83% | 72.00% |
| Filler2 | 1.86% | 1.86% | 1.86% | 1.91% |
| Total Filler (vol %) | 49.8% | 49.8% | 49.8% | 56.5% |
| Solid Filler (vol %) | 44.7% | 44.7% | 44.7% | 51.1% |
| Hollow Filler (vol %) | 5.1% | 5.1% | 5.1% | 5.4% |
| Total Filler + FR (vol %) | 56.5% | 56.5% | 56.5% | 56.5% |
| Initiator | 0.26% | 0.26% | 0.26% | 0.25% |
| Flame Rating (10-mil test coupon) | 94 V0 | Fail | Fail | Fail |
| SPDR 10 GHz | | | | |
| Laminate Thickness (in) | 0.021 | 0.022 | 0.014 | 0.023 |
| Laminate Thickness (μm) | 533.4 | 558.8 | 355.6 | 584.2 |
| Dk | 3.02 | 3.04 | 3.03 | 3.05 |
| Df | 0.00165 | 0.00156 | 0.00151 | 0.00166 |
| Bond to Cu Foil | | | | |
| Air Side (pli) | 2.57 | 2.83 | 2.78 | 3.16 |
| Air Side (N/m) | 450.1 | 495.6 | 486.9 | 553.4 |
| PET Side (pli) | 2.76 | 2.57 | 2.75 | 3.20 |
| PET Side (N/m) | 483.4 | 450.1 | 481.6 | 560.4 |
| Processability | | | | |
| Curl | 1 | 1 | 1 | 1 |
| Flex | 1 | 1 | 1 | 1 |
| Tack/release | 2 | 2 | 2 | 2 |
| CTE-XY ATD puck (ppm/° C.) | | | | |
| −40 to 140° C. | 35 | 42 | 47 | 28 |
| 50 to 150° C. | 40 | 50 | 56 | 32 |
| 150 to 250° C. | 68 | 69 | 73 | 62 |
| −55 to 288° C. | 47 | 53 | 57 | 40 |
| ATD Viscosity (Poise) | | | | |
| Initial (Curable) | 1.9E+07 | 1.5E+07 | 1.6E+07 | 2.2E+07 |
| Minimum | 8.3E+04 | 1.1E+05 | 1.7E+05 | 9.7E+04 |
| Final (Cured) | 8.5E+07 | 7.4E+07 | 6.8E+07 | 9.5E+07 |

Examples 35-38 evaluated SBC2 and SBC3 with FR2. The volume ratio of solid filler to hollow filler was adjusted to 90:10 to decrease the Dk.

TABLE 10

| | Example 35 | Example 36 | Example 37 | Example 38 |
|---|---|---|---|---|
| SBC2 | 14.48% | | 9.65% | 12.07% |
| SBC3 | | 14.48% | | |
| CC1 | 2.41% | 2.41% | 7.24% | 4.83% |
| CC2 | 7.24% | 7.24% | 7.24% | 7.24% |
| FR2 | 6.03% | 6.03% | 6.03% | 6.03% |
| Silane | 0.50% | 0.50% | 0.50% | 0.50% |
| Antioxidant | 0.24% | 0.24% | 0.24% | 0.24% |
| Filler2 | 1.77% | 1.77% | 1.77% | 1.77% |
| Filler6 | 67.08% | 67.08% | 67.08% | 67.08% |
| Total Filler (vol %) | 52.0% | 52.0% | 52.0% | 52.0% |
| Solid Filler (vol %) | 46.8% | 47.0% | 47.0% | 47.0% |
| Hollow Filler (vol %) | 5.2% | 5.0% | 5.0% | 5.0% |
| Total Filler + FR (vol %) | 58.3% | 58.3% | 58.3% | 58.3% |
| Initiator | 0.24% | 0.24% | 0.24% | 0.24% |
| Flame Rating (10-mil test coupon) | Fail | Fail | Fail | Fail |
| SPDR 10 GHz | | | | |
| Laminate Thickness (in) | 0.021 | 0.023 | 0.0237 | 0.0141 |
| Laminate Thickness (μm) | 533.4 | 584.2 | 602.0 | 358.1 |
| Dk | 3.02 | 3.10 | 3.09 | 3.10 |
| Df | 0.00109 | 0.00169 | 0.00207 | 0.00154 |
| Bond to Cu Foil | | | | |
| Air Side (pli) | 2.92 | 2.84 | 2.26 | 2.70 |
| Air Side (N/m) | 511.4 | 497.4 | 395.8 | 472.8 |
| Processability | | | | |
| Curl | 1 | 1 | 1 | 1 |
| Flex | 1 | 1 | 1 | 1 |
| Tack/release | 2 | 2 | 2 | 2 |
| CTE-XY ATD puck (ppm/° C.) | | | | |
| −40 to 140° C. | 46 | 50 | 24 | 37 |
| 50 to 150° C. | 54 | 61 | 23 | 43 |
| 150 to 250° C. | 65 | 68 | 57 | 67 |
| −55 to 288° C. | 54 | 57 | 35 | 48 |
| ATD Viscosity (Poise) | | | | |
| Initial (Curable) | 2.8E+07 | 4.0E+07 | 3.6E+07 | 4.2E+07 |
| Minimum | 6.5E+04 | 2.5E+05 | 8.0E+04 | 5.3E+04 |
| Final (Cured) | 5.5E+07 | 5.0E+07 | 9.0E+07 | 1.0E+08 |

Examples 39-41 evaluated decreased content of SBC2 and SBC3.

TABLE 11

| | Example 39 | Example 40 | Example 41 |
|---|---|---|---|
| SBC1 | | | |
| SBC2 | 12.07% | | 12.07% |
| SBC3 | | 12.07% | |
| CC1 | 4.83% | 4.83% | 4.83% |
| CC2 | 7.24% | 7.24% | 7.24% |
| FR1 | | | 6.03% |
| FR2 | 6.03% | 6.03% | |
| Silane | 0.50% | 0.50% | 0.50% |
| Antioxidant | 0.24% | 0.24% | 0.24% |
| Filler1 | 67.08% | 67.08% | 67.08% |
| Filler2 | 1.77% | 1.77% | 1.77% |
| Total Filler (vol %) | 47.0% | 47.0% | 53.9% |
| Solid Filler (vol %) | 5.0% | 5.0% | 48.7% |
| Hollow Filler (vol %) | 52.0% | 52.0% | 5.1% |
| Total Filler + FR (vol %) | 58.3% | 58.3% | 56.8% |
| Initiator | 0.24% | 0.24% | 0.24% |
| Flame Rating (10-mil test coupon) | 94 V0 | 94 V0 | 94 V0 |
| SPDR 10 GHz | | | |
| Laminate Thickness (in) | 0.021 | 0.020 | 0.022 |
| Laminate Thickness (μm) | 533.4 | 508 | 558.8 |
| Dk | 3.04 | 3.02 | 3.03 |
| Df | 0.00144 | 0.00145 | 0.00140 |
| Bond to Cu Foil | | | |
| Air Side (pli) | 2.81 | 2.68 | 3.15 |
| Air Side (N/m) | 492.1 | 469.3 | 551.6 |
| Processability | | | |
| Curl | 1 | 1 | 1 |
| Flex | 1 | 1 | 1 |
| Tack/release | 2 | 2 | 2 |
| CTE-XY ATD puck (ppm/° C.) | | | |
| −40 to 140° C. | 42 | 45 | 43 |
| 50 to 150° C. | 49 | 53 | 52 |
| 150 to 250° C. | 64 | 68 | 76 |
| −55 to 288° C. | 51 | 53 | 55 |
| ATD Viscosity (Poise) | | | |
| Initial (Curable) | 2.5E+07 | 2.7E+07 | 2.9E+07 |
| Minimum | 6.4E+04 | 4.9E+04 | 6.1E+04 |
| Final (Cured) | 5.0E+07 | 5.1E+07 | 6.2E+07 |

Examples 42-49 evaluated different solid fillers with lower inherent Df values. Substituting the lower Df fillers decreased the vanish overall Df but most examples failed the flame test possibly indicating SBC2 content may have been too high.

TABLE 12

| | Example | Example | Example | Example | Example | Example | Example | Example |
|---|---|---|---|---|---|---|---|---|
| | 42 | 43 | 44 | 45 | 46 | 47 | 48 | 49 |
| SBC2 | 12.07% | 12.07% | 12.07% | 12.07% | 12.07% | 12.07% | 12.07% | 12.44% |
| CC1 | 4.83% | 4.83% | 4.83% | 4.83% | 4.83% | 4.83% | 4.83% | 4.98% |
| CC2 | 7.24% | 7.24% | 7.24% | 7.24% | 7.24% | 7.24% | 7.24% | 7.47% |
| FR2 | 6.03% | 6.03% | 6.03% | 6.03% | 6.03% | 6.03% | 6.03% | 6.22% |
| Silane | 0.50% | 0.50% | 0.50% | 0.50% | 0.50% | 0.50% | 0.50% | 0.50% |
| Antioxidant | 0.24% | 0.24% | 0.24% | 0.24% | 0.24% | 0.24% | 0.24% | 0.25% |
| Filler1 | | | | | | | 67.08% | |
| Filler2 | 1.77% | 1.77% | 1.77% | 1.77% | 1.77% | 1.77% | 1.77% | 1.74% |
| Filler5 | | | | 67.08% | | | | |
| Filler7 | 67.08% | | | | | | | 66.15% |
| Filler8 | | 67.08% | | | | | | |
| Filler9 | | | 67.08% | | | | | |
| Filler10 | | | | | 67.08% | | | |
| Filler11 | | | | | | 67.08% | | |
| Total Filler (vol %) | 52.0% | 52.0% | 52.0% | 52.0% | 52.0% | 52.0% | 52.0% | 50.9% |
| Solid Filler (vol %) | 47.0% | 47.0% | 47.0% | 47.0% | 47.0% | 47.0% | 47.0% | 47.0% |
| Hollow Filler | 5.0% | 5.0% | 5.0% | 5.0% | 5.0% | 5.0% | 5.0% | 5.0% |
| (vol %) | | | | | | | | |
| Total Filler + FR | 58.3% | 58.3% | 58.3% | 58.3% | 58.3% | 58.3% | 58.3% | 57.4% |
| (vol %) | | | | | | | | |
| Initiator | 0.24% | 0.24% | 0.24% | 0.24% | 0.24% | 0.24% | 0.24% | 0.25% |
| Flame Rating (10- | Fail | Fail | Fail | Fai | Fail | Fail | Fail | 94-V0 |
| mil test coupon) | | | | | | | | |
| SPDR 10 GHz | | | | | | | | |
| Laminate | 0.023 | 0.022 | 0.020 | 0.020 | 0.021 | 0.023 | 0.021 | |
| Thickness (in) | | | | | | | | |
| Laminate | 584.2 | 558.8 | 508 | 508 | 533.4 | 584.2 | 533.4 | |
| Thickness (μm) | | | | | | | | |
| Dk | 3.00 | 3.03 | 3.04 | 3.03 | 3.04 | 3.05 | 3.04 | |
| Df | 0.00110 | 0.00113 | 0.00103 | 0.00099 | 0.00116 | 0.00112 | 0.00142 | |
| Bond to Cu Foil | | | | | | | | |
| Air Side (pli) | 1.93 | 2.68 | 2.14 | 2.96 | 2.72 | 2.67 | 2.83 | 2.13 |
| Air Side (N/m) | 338.0 | 469.3 | 374.8 | 518.4 | 476.3 | 467.6 | 495.6 | 373.0 |
| 10 days at | 2.04 | 2.38 | 2.32 | 2.77 | 2.55 | 2.53 | 2.58 | 2.22 |
| 140° C. (pli) | | | | | | | | |
| 10 days at | 357.3 | 416.8 | 406.3 | 485.1 | 446.6 | 443.1 | 451.8 | 388.8 |
| 140° C. (N/m) | | | | | | | | |
| Processability | | | | | | | | |
| Curl | 1 | 1 | 1 | 1 | 1 | 1 | 1 | 1 |
| Flex | 1 | 1 | 1 | 1 | 1 | 1 | 1 | 1 |
| Tack/release | 2 | 2 | 2 | 2 | 2 | 2 | 2 | 2 |
| CTE-XY ATD | | | | | | | | |
| puck (ppm/° C.) | | | | | | | | |
| −40 to 140° C. | 30 | 30 | 34 | 36 | 39 | 44 | 40 | 34 |
| 50 to 150° C. | 32 | 33 | 38 | 41 | 46 | 53 | 46 | 37 |
| 150 to 250° C. | 70 | 60 | 63 | 67 | 71 | 68 | 65 | 70 |
| −55 to 288° C. | 44 | 41 | 44 | 47 | 50 | 54 | 49 | 46 |
| ATD Viscosity | | | | | | | | |
| (Poise) | | | | | | | | |
| Initial | 4.5E+07 | 4.5E+07 | 3.4E+07 | 3.9E+07 | 3.9E+07 | 3.0E+07 | 2.9E+07 | 4.2E+07 |
| (Curable) | | | | | | | | |
| Minimum | 1.3E+05 | 9.5E+04 | 5.1E+04 | 5.3E+04 | 2.2E+05 | 6.6E+04 | 1.2E+05 | 8.4E+04 |
| Final (Cured) | 6.6E+07 | 6.9E+07 | 6.3E+07 | 6.4E+07 | 7.0E+07 | 6.1E+07 | 6.3E+07 | 6.5E+07 |

Experiments were conducted using varying FR2 content and adjusting the polymer ratios of SBC2, CC1, and CC2 to find an acceptable polymer systems and FR content to meet both the flame test and minimum viscosity required for flow. Increased content of FR2 can result in increased Df since the Df of FR2 is greater than 0.003.

Examples 50-53 evaluated various solid filler systems on the Df of the varnish. Filler4, Filler12, and Filler13 have lower Df than Filler1. Decreased total filler volume percent can result in a decreased minimum viscosity.

TABLE 13

| | Example 50 | Example 51 | Example 52 | Example 53 |
|---|---|---|---|---|
| SBC2 | 12.07% | 12.07% | 12.07% | 12.07% |
| CC1 | 4.83% | 4.83% | 4.83% | 4.83% |
| CC2 | 7.24% | 7.24% | 7.24% | 7.24% |
| FR2 | 6.03% | 6.03% | 6.03% | 6.03% |
| Silane | 0.50% | 0.50% | 0.50% | 0.50% |
| Antioxidant | 0.24% | 0.24% | 0.24% | 0.24% |
| Filler1 | 67.08% | | | |
| Filler2 | 1.77% | 1.77% | 1.77% | 1.77% |
| Filler4 | | 67.08% | | |
| Filler12 | | | 67.08% | |
| Filler13 | | | | 67.08% |
| Total Filler (vol %) | 52.0% | 52.0% | 52.0% | 52.0% |
| Solid Filler (vol %) | 47.0% | 47.0% | 47.0% | 47.0% |
| Hollow Filler (vol %) | 5.0% | 5.0% | 5.0% | 5.0% |
| Total Filler + FR (vol %) | 58.3% | 58.3% | 58.3% | 58.3% |
| Initiator | 0.24% | 0.24% | 0.24% | 0.24% |
| SPDR 10 GHz | | | | |
| Laminate Thickness (in) | 0.021 | 0.018 | 0.021 | 0.021 |
| Laminate Thickness (μm) | 533.4 | 457.2 | 533.4 | 533.4 |
| Dk | 3.04 | 3.03 | 3.06 | 3.05 |
| Df | 0.00135 | 0.00104 | 0.00110 | 0.00101 |
| Bond to Cu Foil | | | | |
| Air Side (pli) | 2.69 | 2.92 | 2.76 | 2.65 |
| Air Side (N/m) | 471.1 | 511.4 | 483.4 | 464.1 |
| 10 days at 140° C. (pli) | 2.44 | 2.64 | 2.61 | 2.58 |
| 10 days at 140° C. (N/m) | 427.3 | 462.3 | 457.1 | 451.8 |
| Processability | | | | |
| Curl | 1 | 1 | 1 | 1 |
| Flex | 1 | 1 | 1 | 1 |
| Tack/release | 2 | 2 | 2 | 2 |
| CTE-XY ATD puck (ppm/° C.) | | | | |
| −40 to 140° C. | 44 | 37 | 42 | 34 |
| 50 to 150° C. | 52 | 41 | 49 | 39 |
| 150 to 250° C. | 67 | 71 | 76 | 70 |
| −55 to 288° C. | 54 | 50 | 53 | 47 |
| ATD Viscosity (Poise) | | | | |
| Initial (Curable) | 2.9E+07 | 2.9E+07 | 3.9E+07 | 4.0E+07 |
| Minimum | 8.6E+04 | 4.4E+04 | 1.3E+05 | 1.9E+05 |
| Final (Cured) | 5.7E+07 | 5.9E+07 | 6.5E+07 | 6.4E+07 |

In Examples 54-63 the amount of SBC2 amount was reduced, the ratio of CC1 to CC2 was varied, and FR2 content was increased in an attempt to achieve a V0 flame rating with desirable Df and minimum viscosity. The solid filler was a mixture of Filler4 and Filler5 (about 50:50 by weight). A 90:10 volume ratio of solid to Filler2 was used to maintain a Dk of about 3.0.

TABLE 15

| | Example | Example | Example | Example | Example |
|---|---|---|---|---|---|
| | 54 | 55 | 56 | 57 | 58 |
| SBC2 | 11.90% | 12.05% | 10.20% | 10.31% | 11.86% |
| CC1 | 8.93% | 9.04% | 7.65% | 7.73% | 10.38% |
| CC2 | 8.93% | 9.04% | 7.65% | 7.73% | 7.41% |
| FR2 | 10.42% | 13.55% | 8.93% | 11.60% | 10.38% |
| Silane | 0.50% | 0.51% | 0.50% | 0.49% | 0.50% |
| Antioxidant | 0.30% | 0.30% | 0.26% | 0.26% | 0.30% |
| Filler2 | 1.58% | 1.49% | 1.74% | 1.66% | 1.59% |
| Filler4/Filler5 Blend | 57.14% | 53.73% | 62.81% | 59.97% | 57.28% |
| Total Filler (vol %) | 41.8% | 38.8% | 47.8% | 45.2% | 41.8% |
| Solid Filler (vol %) | 37.6% | 34.9% | 43.1% | 40.7% | 37.6% |
| Hollow Filler (vol %) | 4.2% | 3.9% | 4.8% | 4.5% | 4.2% |
| Total Filler + FR (vol %) | 52.0% | 52.0% | 57.0% | 57.0% | 52.0% |
| Initiator | 0.30% | 0.30% | 0.26% | 0.26% | 0.30% |
| Flame Rating (10-mil test coupon) | 94 V0 | 94 V0 | 94 V0 | 94 V0 | 94 V0 |
| Flame Rating (20-mil test coupon) | 94 V0 | 94 V0 | 94 V0 | 94 V0 | 94 V0 |
| SPDR 10 GHz | | | | | |
| Laminate Thickness (in) | 0.022 | 0.022 | 0.022 | 0.021 | 0.022 |
| Laminate Thickness (μm) | 558.8 | 558.8 | 558.8 | 533.4 | 558.8 |
| Dk | 2.94 | 3.01 | 2.97 | 2.96 | 2.90 |
| Df | 0.00127 | 0.00132 | 0.00119 | 0.00120 | 0.00125 |
| Bond to Cu Foil | | | | | |
| Air Side (pli) | 2.62 | 2.48 | 2.62 | 2.42 | 2.62 |
| Air Side (N/m) | 458.8 | 434.3 | 458.8 | 423.8 | 458.8 |
| 10 days at 140° C. (pli) | 2.60 | 2.40 | 2.49 | 2.30 | 2.60 |
| 10 days at 140° C. (N/m) | 455.3 | 420.3 | 436.1 | 402.8 | 455.3 |
| Processability | | | | | |
| Curl | 1 | 1 | 1 | 1 | 3 |
| Flex | 1 | 1 | 2 | 2 | 2 |
| Tack/release | 2 | 1 | 1 | 1 | 2 |
| CTE-XY ATD puck (ppm/° C.) | | | | | |
| −40 to 140° C. | 37 | 46 | 29 | 32 | 43 |
| 50 to 150° C. | 41 | 53 | 30 | 34 | 50 |
| 150 to 250° C. | 77 | 83 | 67 | 66 | 85 |
| −55 to 288° C. | 51 | 58 | 42 | 44 | 58 |
| ATD Viscosity (Poise) | | | | | |
| Initial (Curable) | 3.8E+07 | 3.9E+07 | 4.7E+07 | 5.1E+07 | 5.5E+07 |
| Minimum | 1.7E+04 | 1.4E+04 | 3.1E+04 | 4.1E+04 | 1.8E+04 |
| Final (Cured) | 7.4E+07 | 6.8E+07 | 8.0E+07 | 8.0E+07 | 6.7E+07 |

TABLE 16

| | Example | Example | Example | Example | Example |
|---|---|---|---|---|---|
| | 59 | 60 | 61 | 62 | 63 |
| SBC2 | 12.00% | 10.17% | 10.27% | 11.27% | 11.22% |
| CC1 | 10.50% | 8.90% | 8.98% | 8.46% | 9.82% |
| CC2 | 7.50% | 6.35% | 6.42% | 8.46% | 7.01% |
| FR2 | 13.50% | 8.90% | 11.55% | 11.27% | 11.22% |
| Silane | 0.50% | 0.50% | 0.50% | 0.50% | 0.50% |
| Antioxidant | 0.30% | 0.25% | 0.26% | 0.28% | 0.28% |
| Filler2 | 1.50% | 1.75% | 1.67% | 1.61% | 1.60% |
| Filler4/Filler5 Blend | 53.89% | 62.93% | 60.09% | 57.87% | 58.05% |
| Total Filler (vol %) | 38.9% | 47.9% | 45.3% | 42.8% | 42.8% |
| Solid Filler (vol %) | 35.0% | 43.1% | 40.7% | 38.5% | 38.6% |
| Hollow Filler (vol %) | 3.9% | 4.8% | 4.5% | 4.3% | 4.3% |
| Total Filler + FR (vol %) | 52.0% | 57.0% | 57.0% | 54.0% | 54.0% |
| Initiator | 0.30% | 0.25% | 0.26% | 0.28% | 0.28% |
| Flame Rating (10-mil test coupon) | 94 V0 | 94 V0 | 94 V0 | 94 V0 | 94 V0 |
| Flame Rating (20-mil test coupon) | 94 V0 | 94 V1 | 94 V0 | 94 V0 | 94 V1 |
| SPDR 10 GHz | | | | | |
| Laminate Thickness (in) | 0.022 | 0.022 | 0.022 | 0.024 | 0.023 |
| Laminate Thickness (μm) | 558.8 | 558.8 | 558.8 | 609.6 | 584.2 |
| Dk | 2.94 | 2.96 | 2.94 | 2.97 | 2.95 |
| Df | 0.00132 | 0.00115 | 0.00116 | 0.00126 | 0.00119 |
| Bond to Cu Foil | | | | | |
| Air Side (pli) | 2.51 | 2.57 | 2.38 | 2.44 | 2.51 |
| Air Side (N/m) | 439.6 | 450.1 | 416.8 | 427.3 | 439.6 |
| 10 days at 140° C. (pli) | 2.39 | 2.49 | 2.37 | 2.33 | 2.49 |
| 10 days at 140° C. (N/m) | 418.6 | 436.1 | 415.1 | 408.0 | 436.1 |
| Processability | | | | | |
| Curl | 3 | 3 | 3 | 1 | 3 |
| Flex | 2 | 4 | 4 | 2 | 3 |
| Tack/release | 1 | 1 | 1 | 1 | 1 |
| CTE-XY ATD puck (ppm/° C.) | | | | | |
| −40 to 140° C. | 48 | 31 | 33 | 37 | 40 |
| 50 to 150° C. | 56 | 34 | 35 | 41 | 45 |
| 150 to 250° C. | 79 | 75 | 77 | 76 | 78 |
| −55 to 288° C. | 59 | 44 | 47 | 50 | 54 |
| ATD Viscosity (Poise) | | | | | |
| Initial (Curable) | 4.7E+07 | 7.6E+07 | 7.3E+07 | 4.4E+07 | 6.8E+07 |
| Minimum | 1.7E+04 | 4.8E+04 | 4.6E+04 | 2.5E+04 | 2.5E+04 |
| Final (Cured) | 6.1E+07 | 8.0E+07 | 7.7E+07 | 7.3E+07 | 7.1E+07 |

With reference to Examples 64-81, curable compositions for build-up films were prepared according to the following general procedure. Polymeric components were blended in a toluene solution. Filler and other additives were then blended under shear with the polymeric components to provide a varnish. Varnishes including the curable compositions were cast onto a polymeric carrier. Varnishes including the curable compositions were cast onto a polymeric carrier.

Examples 64-68 are summarized in Table 17. All percentages are weight percent, unless indicated otherwise.

In Examples 64-68, the permittivity (Dk) and the dielectric loss (Df) were measured in accordance with the “Split Post Dielectric Resonator (SPDR) Technique for Precise Measurements of Laminar Dielectric Specimens” (IEEE Xplore Conference Paper, February 2000) at a temperature of 23 to 25° C., 50% relative humidity and at a frequency of 10 gigahertz (GHz).

The minimum melt viscosity (MMV) was determined using parallel plate oscillatory rheology with a ramping temperature of 10° C. per minute. The viscosity and temperature where the film starts to soften as it goes into a minimum melt and before the cross-linker begins to pick up molecular weight is taken as the minimum melt viscosity and corresponding temperature.

The glass transition temperature (Tg) was determined in accordance with IPC™ 650 2.4.24, which specifies the measurement of Tg for organic films using dynamic mechanical analysis (DMA).

TABLE 17

| | Example | Example | Example | Example | Example |
|---|---|---|---|---|---|
| | 64 | 65 | 66 | 67 | 68 |
| SBC1 | 6.68 | 11.69 | 6.68 | 11.69 | 11.69 |
| CC1 | 13.37 | 10.85 | 13.37 | 10.85 | 10.85 |
| CC2 | 13.37 | 10.85 | 13.37 | 10.85 | 10.85 |
| Silane | 0.5 | 0.5 | 0.5 | 0.5 | 0.5 |
| Antioxidant | 0.33 | 0.33 | 0.33 | 0.33 | 0.33 |
| Filler14 | 65.51 | 65.53 | 65.51 | 65.53 | |
| Filler15 | | | | | 65.53 |
| Total Filler (vol %) | 44.8 | 44.8 | 44.8 | 44.8 | |
| Initiator 1 | 0.24 | 0.24 | | | 0.24 |
| Initiator2 | | | 0.24 | 0.24 | |
| CC1:CC2 | 1:1 | 1:1 | 1:1 | 1:1 | 1:1 |
| Dk (@10 GHz) | | 3.03 | | 3.03 | 3.05 |
| Df (@10 GHz) | | 0.00103 | | 0.00121 | 0.00164 |
| MMV (Poise) | | 71,409 | | 82,741 | |
| Tg by dynamic mechanical | | 231.9 | | 239.9 | |
| analysis (DMA) (° C.) | | | | | |
| CTE XY-axis | | | | | |
| −50° C. to 150° C. (μm/m° C.) | | | | | 22.92 |
| 150° C. to 250° C. (μm/m° C.) | | | | | 61.36 |
| −50° C. to 250° C. (μm/m° C.) | | | | | 30.01 |
| Peel Strength | | | | | |
| Side 1- ED foil (0.5 oz) (N/mm) | | | | | 0.43 |
| Side 2 - ED foil (0.5 oz) (N/mm) | | | | | 0.32 |
| Solder Float (288° C.) (Pass/Fail) | | | | | Pass |

SBC1 was evaluated at 6.68 weight percent and 11. weight percent, with the difference being added to CC1 and CC2 (at 1:1 ratio). Films formulated with 6.68 weight percent SBC1, 13.37 weight percent CC1, and 13.37 weight percent CC2 were brittle and could not be further evaluated. Example 65 was selected for further testing.

TABLE 18a

| | Example 69 | Example 70 | Example 71 | Example 72 |
|---|---|---|---|---|
| SBC1 | 8.00 | 8.00 | 15.00 | 12.85 |
| CC1 | 13.00 | 13.00 | 8.00 | 13.00 |
| CC2 | 13.00 | 13.00 | 10.80 | 8.00 |
| Silane | 0.60 | 0.30 | 0.60 | 0.60 |
| Antioxidant | 0.30 | 0.40 | 0.30 | 0.40 |
| Filler14 | 64.95 | 65.00 | 65.00 | 65.00 |
| Total Filler (vol %) | 44.4 | 44.4 | 44.4 | 44.4 |
| Initiator2 | 0.15 | 0.30 | 0.30 | 0.15 |
| CC1:CC2 | 1:1 | 1:1 | 0.741:1 | 1.625:1 |
| Dk | 3.08 | 3.01 | 3.04 | 3.07 |
| Df | 0.00141 | 0.00139 | 0.00125 | 0.00121 |
| MMV (Poise) | 39,307 | 36,715 | 97,601 | 68,045 |
| Tg by dynamic mechanical | 223.9 | 230.8 | 224.5 | 221.5 |
| analysis (DMA) (° C.) | | | | |
| CTE XY-axis (−50° C. to 150° C.) | 27.41 | 29.74 | 78.97 | 48.65 |
| (micrometers (μm)/meter (m)° C.) | | | | |

TABLE 18b

| | Example 73 | Example 74 | Example 75 | Example 76 | Example 77 |
|---|---|---|---|---|---|
| SBC1 | 12.82 | 15.00 | 12.85 | 15.00 | 15.00 |
| CC1 | 10.99 | 13.00 | 13.00 | 13.00 | 8.00 |
| CC2 | 11.63 | 8.00 | 8.00 | 13.00 | 13.00 |
| Silane | 0.45 | 0.30 | 0.60 | 0.60 | 0.30 |
| Antioxidant | 0.35 | 0.30 | 0.40 | 0.40 | 0.40 |
| Filler14 | 63.52 | 63.25 | 65.00 | 57.70 | 63.15 |
| Total Filler (vol %) | 46.4 | 43.2 | 44.4 | 39.4 | 43.2 |
| Initiator2 | 0.23 | 0.15 | 0.15 | 0.30 | 0.15 |
| CC1:CC2 | 0.945:1 | 1.625:1 | 1.625:1 | 1:1 | 0.615:1 |
| Dk | 3.02 | 3.06 | 3.04 | 2.96 | 3.03 |
| Df | 0.00115 | 0.00095 | 0.00091 | 0.00111 | 0.00098 |
| MMV (Poise) | 64,641 | 99,284 | 111,480 | 34,375 | 54,627 |
| Tg by dynamic mechanical | 222.2 | 216.8 | 218.3 | 215.5 | 208.8 |
| analysis (DMA) (° C.) | | | | | |
| CTE XY-axis (−50° C. to | 40.72 | 58.93 | 45.15 | 65.82 | 61.87 |
| 150° C.) (um/m° C.) | | | | | |

The results of the testing summarized in Table 18a and Table 18b indicate that the amounts of CC1, CC2, and filler (e.g., Filler14) have a large impact on CTE. Among the formulation constituents, the filler with the lowest intrinsic CTE can exert the largest influence on reducing the composite CTE, as the filler content is increased. At a fixed filler content, increasing the proportions of CC1 and CC2 while decreasing the SBC content can raise the crosslink density of the thermoset network, and the CTE can be further reduced.

The formulation of Example 66 was coated via a slot die coating process on a polyethylene terephthalate (PET) carrier at a thickness of 1.2 μm. Results are shown in Table 19.

TABLE 19

| | | | | | | Avg of |
|---|---|---|---|---|---|---|
| | | Example | Example | Example | Example | Examples |
| | | 78 | 79 | 80 | 81 | 78-81 |
| Dk (@10 GHz) | | 3.01 | 3.04 | 3.02 | 3 | 3.01 |
| Df (@10 GHz) | | 0.00118 | 0.00134 | 0.00123 | 0.00109 | 0.00114 |
| CTE XY-axis | | | | | | |
| −50° C. to 150° C. | μm/m° C. | 24.78 | 22.28 | 27.55 | 25.13 | 24.94 |
| 150° C. to 250° C. | μm/m° C. | 74.97 | 65.62 | 85.39 | 68.61 | 73.65 |
| −50° C. to 250° C. | μm/m° C. | 33.4 | 29.89 | 37.65 | 30.76 | 32.93 |
| Tg | | | | | | |
| by TMA | ° C. | 185 | 193 | 193 | 188 | 187 |
| by DMA | ° C. | 229.3 | 230.1 | 227.3 | 227.8 | 228.6 |
| MMV | Poise | 69,500 | 65,231 | 82,474 | 78,241 | 73,871 |
| Modulus | | | | | | |
| by DMA at 25° C. | MPa | 5,912 | 6,052 | 6,112 | 6,030 | 6,027 |
| by DMA at 150C° C. | MPa | 3,241 | 3,291 | 3,334 | 3,181 | 3,262 |
| Peel Strength | | | | | | |
| Side 1- ED foil (0.5 oz) | N/mm | 0.319 | 0.403 | 0.333 | 0.385 | 0.360 |
| Side 2 - ED foil (0.5 oz) | N/mm | 0.149 | 0.175 | 0.193 | 0.198 | 0.179 |
| Enthalpy | j/g | 44.21 | 45.71 | 50.66 | 43.26 | 43.74 |
| Specific Gravity | | 1.56 | 1.56 | 1.58 | 1.57 | 1.57 |
| Ash - thermal gravimetric | % | 67.6 | 65.3 | 69.1 | 68.6 | 67.6 |
| analysis | | | | | | |
| Td - 5% | ° C. | 434 | 429 | 438 | 440 | 437 |
| Solder Float (288° C.) | Pass/Fail | Pass | Pass | Pass | Pass | N/A |
| H₂O Absorption | | | | | | |
| 24 hrs at RT | % | 0.06 | 0.05 | 0.07 | 0.06 | 0.06 |
| 48 hrs at 50° C. | % | 0.11 | 0.11 | 0.11 | 0.12 | 0.12 |

There is a difference in peel strength depending on the side of the film which is evaluated against the conductor. Side 2 is the side interface with PET carrier during the coating and has a shiny appearance. Side 1 is the side of the film which is opposite side 2 and has a matte appearance.

Set forth below are non-limiting aspects of this disclosure.

Aspect 1: A curable composition comprising 4.9 to 15 weight percent, or 4.9 to 14 weight percent, or 4.9 to 13 weight percent, or 4.9 to 12 weight percent, of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene; 4 to 13 weight percent, or 5 to 12 weight percent, or 5 to 11 weight percent, of a first crosslinkable component comprising a polymeric reactive diluent having a glass transition temperature of greater than or equal to 100° C. and at least one crosslinkable reactive group; and 4 to 13 weight percent, or 5 to 12 weight percent, or 5 to 11 weight percent, of a second crosslinkable component comprising a polyaromatic vinyl compound; wherein weight percent of each component is based on a total weight of dry components of the curable composition, and wherein the curable composition further comprises 36 to 54 volume percent, or 36 to 51 volume percent, of a filler; wherein volume percent of the filler is based on a total volume of dry components of the curable composition.

Aspect 2: The curable composition of aspect 1 comprising 4.9 to 12 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene; 5 to 11 weight percent of a first crosslinkable component comprising a polymeric reactive diluent having a glass transition temperature of greater than or equal to 100° C. and at least one crosslinkable reactive group; and 5 to 11 weight percent of a second crosslinkable component comprising a polyaromatic vinyl compound; wherein weight percent of each component is based on a total weight of dry components of the curable composition; and wherein the curable composition further comprises 36 to 51 volume percent of a filler, wherein volume percent of the filler is based on a total volume of dry components of the curable composition.

Aspect 3: The curable composition of aspect 1 comprising 4.9 to 11.6 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene; 6.4 to 10 weight percent of a first crosslinkable component comprising a polymeric reactive diluent having a glass transition temperature of greater than or equal to 100° C. and at least one crosslinkable reactive group; 5.1 to 8.8 weight percent of a second crosslinkable component comprising a polyaromatic vinyl compound; and 61.2 to 69.8 weight percent of a filler; wherein weight percent of each component is based on a total weight of dry components of the curable composition.

Aspect 4: The curable composition of any one of aspects 1 to 3, wherein a weight ratio of the first crosslinkable component to the second crosslinkable component is in a range of 0.6:1 to 2:1 or 0.727:1 to 1.96:1.

Aspect 5: The curable composition of any of aspects 1 to 4, wherein the second crosslinkable component is represented by formula (1):

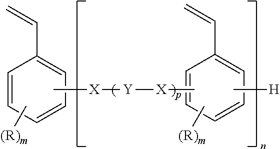

wherein X and Y each represent an organic group, wherein each X is the same as or different from each other, and wherein each Y is the same as or different from each other, R is a hydrocarbon group having 1 to 10 carbon atoms or a halogenated alkyl group, wherein each R is the same as or different from each other, m is an integer of 0 to 3, 1≤n≤20, and 0≤p≤20.

Aspect 6: The curable composition of any of aspects 1 to 4, wherein the second crosslinkable component is represented by formula (4)

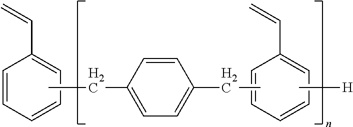

wherein 1≤n≤20.

Aspect 7: The curable composition of any of aspects 1 to 6, wherein each A block of the hydrogenated block copolymer is derived from para-methylstyrene; each B block of the hydrogenated block copolymer is a copolymer derived from para-methylstyrene and a conjugated diene of isoprene, butadiene, or a combination thereof, wherein the B block has a conjugated diene content of 10 to 55%; wherein each A block has a peak molecular weight of 3 to 60 kg/mol and each B block has a peak molecular weight of 20 to 200 kg/mol.

Aspect 8: The curable composition of any of aspects 1 to 7, wherein the polymeric reactive diluent has a glass transition temperature of 100 to 300° C.

Aspect 9: The curable composition of any of aspects 1 to 8, wherein the filler comprises silica.

Aspect 10: The curable composition of any of aspects 1 to 9, wherein the filler comprises a mixture of solid silica particles and hollow soda-lime-borosilicate glass microspheres.

Aspect 11: The curable composition of any of aspects 1 to 9, wherein the filler comprises a combination of solid silica particles and hollow silica particles.

Aspect 12: The curable composition of any of aspects 1 to 11, further comprising an initiator, for example, a peroxide initiator, such as dicumyl peroxide, 2,5-dimethyl-2,5-di(t-butylperoxy)hexane, α,α′-di(t-butylperoxy)diisopropylbenzene, 2,5-dimethyl-2,5-di(t-butylperoxy)hexyne, or 3,1,1-di(t-butylperoxy)-3,5,5-trimethylcyclohexane.

Aspect 13: The curable composition of any of aspects 1 to 12, further comprising a flame retardant, for example, 6.4 to 13.7 weight percent of the flame retardant, based on the total weight of the dry components of the curable composition.

Aspect 14: The curable composition of any of aspects 1 to 12, further comprising a brominated flame retardant, for example, or 7 to 16.5 weight percent, or 7 to 14 weight percent, or 7 to 11.5 weight percent, of the brominated flame retardant, based on the total weight of the dry components of the curable composition.

Aspect 15: The curable composition of any of aspects 1 to 12, further comprising a halogen-free flame retardant, for example, 8 to 16.5 weight percent, or 8 to 14 weight percent, or 8 to 11.5 weight percent, of the halogen-free flame retardant, based on the total weight of the dry components of the curable composition.

Aspect 16: The curable composition of any of aspects 1 to 12, wherein the curable composition comprises less than 10 weight percent, or less than 5 weight percent, or less than 1 weight percent, or 0 weight percent, of a flame retardant, based on the total weight of the dry components of the curable composition.

Aspect 17: The curable composition of any of aspects 1 to 16, further comprising an additive composition, for example, wherein the additive composition comprises an antioxidant and a silane.

Aspect 18: The curable composition of any of aspects 1 to 17, wherein each A block of the hydrogenated block copolymer is derived from para-methylstyrene; each B block of the hydrogenated block copolymer is a copolymer derived from para-methylstyrene and a conjugated diene of isoprene, butadiene, or a combination thereof, wherein the B block has a conjugated diene content of 10 to 55%; wherein each A block has a peak molecular weight of 3 to 60 kg/mol and each B block has a peak molecular weight of 20 to 200 kg/mol; and the filler comprises silica.

Aspect 19: The curable composition of any of aspects 1 to 18, having a minimum viscosity of less than 4.9E+04.

Aspect 20: A varnish comprising the curable composition of any of aspects 1 to 19 and a solvent.

Aspect 21: A cured composition obtained from the curable composition of any of aspects 1 to 19 or the varnish of aspect 20.

Aspect 22: The cured composition of aspect 21, wherein the cured composition exhibits one or more of a dissipation factor (Df) of 0.0006 to 0.005, or 0.001 to 0.003, or 0.001 to 0.0025, or 0.001 to 0.002, at 10 GHz; a dielectric constant (Dk) of 2.9 to 3.4 at 10 GHz; a coefficient of thermal expansion of less than or equal to 5 to 40 parts per million/° C., or 5 to 30 parts per million/° C., or 5 to 20 parts per million/° C., or 3 to 20 parts per million/° C., measured with thermomechanical analysis over a temperature range of −40 to 140° C.; a peel strength from copper of 0.5 to 5.5 pounds per linear inch (87.6 to 963.2 newtons per meter), or 1 to 5 pounds per linear inch (175.1 to 875.6 newtons per meter); and a UL94 flammability rating of V-0.

Aspect 23: A cured composition obtained from the curable composition of any of aspects 1 to 21, wherein the cured composition exhibits one or more of a dissipation factor (Df) of 0.0006 to 0.005, or 0.001 to 0.003, or 0.001 to 0.0025, or 0.001 to 0.002, at 10 GHz; a dielectric constant (Dk) of 2.9 to 3.4 at 10 GHz; a coefficient of thermal expansion of less than or equal to 5 to 40 parts per million/° C., or 5 to 30 parts per million/° C., or 5 to 20 parts per million/° C., or 3 to 20 parts per million/° C., measured with thermomechanical analysis over a temperature range of −40 to 140° C.; a peel strength from copper of 0.5 to 5.5 pounds per linear inch (87.6 to 963.2 newtons per meter), or 1 to 5 pounds per linear inch (175.1 to 875.6 newtons per meter); and a UL94 flammability rating of V-0.

Aspect 24: A cured composition obtained from the curable composition of any of aspects 1 to 21, wherein the cured composition exhibits one or more of a dissipation factor (Df) of less than 0.0014 or 0.0005 to 0.0014, at 10 GHz; a dielectric constant (Dk) of 2.5 to 3.4 or 2.5 to 2.9 at 10 GHz; a coefficient of thermal expansion of less than or equal to 5 to 40 parts per million/° C., or 5 to 30 parts per million/° C., or 5 to 20 parts per million/° C., or 3 to 20 parts per million/° C., measured with thermomechanical analysis over a temperature range of −40 to 140° C.; a peel strength from copper of 0.5 to 5.5 pounds per linear inch (87.6 to 963.2 newtons per meter), or 1 to 5 pounds per linear inch (175.1 to 875.6 newtons per meter); and a UL94 flammability rating of V-0.

Aspect 25: The cured composition of any of aspects 21 or 24, wherein the cured composition is in the form of a film.

Aspect 26: The cured composition of aspect 25, wherein the film has a thickness of 10 to 130 micrometers.

Aspect 27: The cured composition of aspect 25, wherein the film has a thickness of 10 to 100 micrometers.

Aspect 28: A composite laminate comprising the cured composition of any of aspects 25 to 27.

Aspect 29: The composite laminate of aspect 28, wherein the cured composition is in contact with a reinforcing layer, for example, a glass fiber reinforcing layer.

Aspect 30: A bondply comprising a composite laminate comprising the cured composition of any of aspects 21 to 24, wherein the cured composition is in the form of a film, and wherein the cured composition is not in contact with a reinforcing layer, for example, a glass fiber reinforcing layer.

Aspect 31: A build-up film comprising the cured composition of any of aspects 21 to 27.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced items. Reference to “an” element in a claim followed by reference to “the” element is inclusive of one element and a plurality of the elements. The term “or” means “and/or” unless clearly indicated otherwise by context. Reference throughout the specification to “an aspect,” “another aspect,” and so forth, means that a particular element (e.g., feature, structure, step, or characteristic) described in connection with the aspect is included in at least an aspect described herein, and may or may not be present in other aspects. In addition, it is to be understood that the described elements can be combined in any suitable manner in the various aspects.

When an element such as a layer, film, region, or substrate is referred to as being “on” another element, it can be directly on the other element or intervening elements can also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.). The terms “first,” “second,” and the like, “primary,” “secondary,” and the like, as used herein do not denote any order, quantity, or importance, but rather are used to distinguish one element from another. The term “combination thereof” is open, and means that the list is inclusive of each element individually, as well as combinations of two or more elements of the list, and combinations of at least one element of the list with like elements not named. Also, the term “combination” is inclusive of blends, mixtures, alloys, reaction products, and the like.

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular aspects have been described, alternatives, modifications, variations, improvements, and substantial equivalents that are or can be presently unforeseen may arise to applicants or others skilled in the art. Accordingly, the appended claims as filed and as they may be amended are intended to embrace all such alternatives, modifications variations, improvements, and substantial equivalents.

1. A curable composition comprising:
4.9 to 15 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene;
4 to 13 weight percent of a first crosslinkable component comprising a polymeric reactive diluent having a glass transition temperature of greater than or equal to 100° C. and at least one crosslinkable reactive group; and
4 to 13 weight percent of a second crosslinkable component comprising a polyaromatic vinyl compound;
wherein weight percent of each component is based on a total weight of dry components of the curable composition; and
wherein the curable composition further comprises 36 to 54 volume percent of a filler, wherein volume percent of the filler is based on a total volume of dry components of the curable composition.

2. The curable composition of claim 1 comprising:
4.9 to 12 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene;
5 to 11 weight percent of a first crosslinkable component comprising a polymeric reactive diluent having a glass transition temperature of greater than or equal to 100° C. and at least one crosslinkable reactive group; and
5 to 11 weight percent of a second crosslinkable component comprising a polyaromatic vinyl compound;
wherein weight percent of each component is based on a total weight of dry components of the curable composition; and
wherein the curable composition further comprises 36 to 51 volume percent of a filler, wherein volume percent of the filler is based on a total volume of dry components of the curable composition.

3. The curable composition of claim 1 comprising:
4.9 to 11.6 weight percent of a hydrogenated block copolymer comprising at least one A block and at least one B block, wherein prior to hydrogenation, each A block is a polymer of a first vinyl aromatic compound, and each B block is a copolymer of a second vinyl aromatic compound and a conjugated diene;
6.4 to 10 weight percent of a first crosslinkable component comprising a polymeric reactive diluent having a glass transition temperature of greater than or equal to 100° C. and at least one crosslinkable reactive group;
5.1 to 8.8 weight percent of a second crosslinkable component comprising a polyaromatic vinyl compound; and
61.2 to 69.8 weight percent of a filler;
wherein weight percent of each component is based on a total weight of dry components of the curable composition.

4. The curable composition of claim 1, wherein a weight ratio of the first crosslinkable component to the second crosslinkable component is in a range of 0.6:1 to 2:1.

5. The curable composition of claim 1, wherein the second crosslinkable component is represented by formula (1): 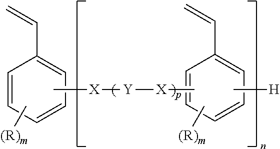
wherein
X and Y each represent an organic group, wherein each X is the same as or different from each other, and wherein each Y is the same as or different from each other,
R is a hydrocarbon group having 1 to 10 carbon atoms or a halogenated alkyl group, wherein each R is the same as or different from each other,
m is an integer of 0 to 3,
1≤n≤20, and
0≤p≤20.

6. The curable composition of claim 1, wherein the second crosslinkable component is represented by formula (4) 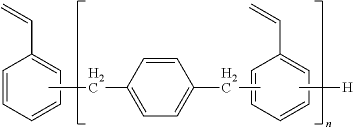
wherein 1≤n≤20.

7. The curable composition of claim 1, wherein
each A block of the hydrogenated block copolymer is derived from para-methylstyrene;
each B block of the hydrogenated block copolymer is a copolymer derived from para-methylstyrene and a conjugated diene of isoprene, butadiene, or a combination thereof, wherein the B block has a conjugated diene content of 10 to 55%;
wherein each A block has a peak molecular weight of 3 to 60 kg/mol and each B block has a peak molecular weight of 20 to 200 kg/mol.

8. The curable composition of claim 1, wherein the polymeric reactive diluent has a glass transition temperature of 100 to 300° C.

9. The curable composition of claim 1, wherein the filler comprises silica.

10. The curable composition of claim 1, wherein the filler comprises a mixture of solid silica particles and hollow soda-lime-borosilicate glass microspheres.

11. The curable composition of claim 1, further comprising an initiator.

12. The curable composition of claim 1, further comprising a flame retardant.

13. The curable composition of claim 1, further comprising a brominated flame retardant.

14. The curable composition of claim 1, further comprising a halogen-free flame retardant.

15. The curable composition of claim 1, wherein the curable composition comprises less than 10 weight percent of a flame retardant, based on the total weight of the dry components of the curable composition.

16. The curable composition of claim 1, wherein
each A block of the hydrogenated block copolymer is derived from para-methylstyrene;
each B block of the hydrogenated block copolymer is a copolymer derived from para-methylstyrene and a conjugated diene of isoprene, butadiene, or a combination thereof, wherein the B block has a conjugated diene content of 10 to 55%;
wherein each A block has a peak molecular weight of 3 to 60 kg/mol and each B block has a peak molecular weight of 20 to 200 kg/mol; and
the filler comprises silica.

17. The curable composition of claim 1, having a minimum viscosity of less than 4.9E+04.

18. A cured composition obtained from the curable composition of claim 1, wherein the cured composition exhibits one or more of:
a dissipation factor (Df) of less than 0.0014, at 10 GHz;
a dielectric constant (Dk) of 2.5 to 3.4 at 10 GHz;
a coefficient of thermal expansion of less than or equal to 5 to 40 parts per million/° C., measured with thermomechanical analysis over a temperature range of −40 to 140° C.;
a peel strength from copper of 0.5 to 5.5 pounds per linear inch (87.6 to 963.2 newtons per meter); and
a UL94 flammability rating of V-0.

19. A bondply comprising a composite laminate comprising the cured composition of claim 18, wherein the cured composition is in the form of a film, and wherein the cured composition is not in contact with a reinforcing layer.

20. A build-up film comprising the cured composition of claim 18.
